(19) United States
(12) Patent Application Publication
(10) Pub. No.: US 2023/0004050 A1
(43) Pub. Date: Jan. 5, 2023

(54) ELECTRODE STRUCTURE FOR CREATING ELECTRICAL POTENTIAL GRADIENT

(71) Applicant: UNIVERSITÉ LAVAL, Québec (CA)

(72) Inventor: Tigran GALSTIAN, Québec (CA)

(21) Appl. No.: 17/783,539

(22) PCT Filed: Dec. 8, 2020
(86) PCT No.: PCT/CA2020/051688

§ 371 Date: Jun. 8, 2022

Related U.S. Application Data
(60) Provisional application No. 63/068,731, filed on Aug. 21, 2020.
(60) Provisional application No. 62/945,285, filed on Dec. 9, 2019.

(51) Int. Cl. G02F 1/1343; G02F 1/1337; G02F 1/29

(52) U.S. Cl. CPC G02F 1/134309; G02F 1/133707; G02F 1/294

(57) ABSTRACT

The present application relates to liquid crystal optical devices. It has been discovered that the problem of electric field discontinuity due to a discrete electrode arrangement in an LC-GRIN (or TLCL) optical device having a stepped voltage distribution in space can be solved by the use of phase shifted drive signals while using discrete shaped electrodes or by the use of a relatively high dielectric constant layer (HDCL), placed near the stepped electrode, which can “smoothen” the electric potential profile and reduce the artifacts due to the steps in electric field caused by the discrete turns or steps of the stepped electrode. Such HDCLs may be fabricated much easier compared to weakly conductive layers (WCLs).

The present patent application claims priority to U.S. provisional patent applications 62/945,285 filed on 9 Dec. 2019 and 63/068,731 filed on 21 Aug. 2020, the contents of which are hereby incorporated by reference.

### TECHNICAL FIELD

The present patent application relates to liquid crystal optical devices.

### BACKGROUND

Optical gradient index devices are well known in the prior art, e.g., gradient index lenses and prisms (Moore, D. T., Gradient-index optics: a review. Applied Optics, 1980. 19(7): p. 1035-1038). Making these devices adaptable (enabling the dynamic change of their gradient) can increase significantly their functionality and efficiency. This would require optical materials that are sensitive to external stimuli. Various materials, including liquid crystals (LC) are sensitive to such stimuli, e.g., electric or magnetic fields (de Gennes, P.-G. and J. Prost, The physics of liquid crystals. Oxford University Press, USA, 1995. 2: p. 4). Thus, we could use electric field gradients to obtain the desired profile of refractive index by using LC materials (e.g., to build an electrically tunable LC lens or TLCL).

Indeed, different techniques have been developed to obtain such a gradient of electric field. One of the most straightforward ways is the use of patterned (circular, to obtain a lens, or linear, to obtain a prism) electrodes in a sandwich device (made of two substrates) containing the LC material. In the case of a lens-type device, one of its substrates is usually covered by a uniform transparent electrode (indium tin oxide or ITO), while the second one has a hole patterned electrode (HPE), FIG. 1a. In this case, the electric field will be strong in the periphery (where the HPE is facing the uniform ITO electrode) and will be decreasing when we consider positions closer to the center of the device (far from the HPE). The electric field's decrease will be gradual at distances comparable with the separation D (shown on FIG. 1b) of two electrode planes (thanks to the so-called «fringing field» effect), but it will be significant if the diameter of the HPE (or the clear aperture, CA, of the device, shown on FIG. 1a) is much larger compared to the D (in FIG. 1a, we have a case when D=L, where L is the thickness of the LC layer). Thus, the electric field's profile, the reaction of the LC and the corresponding profile of the refractive index gradient will be defined by the ratio of CA over D. In fact, it was shown that the best ratio R=CA/D should be at the order of 2.5 to have a soft change of the electric gradient allowing the generation of an optical gradient index lens with acceptable aberrations (Sato, S., Applications of liquid crystals to variable-focusing lenses. Optical Review, 1999. 6(6): p. 471-485.)

However, there are several limitations here: the choice of the thickness L of the LC is usually limited (L must be relatively small because of light scattering and relaxation time requirements) and the separation of electrodes D must be as small as possible to limit voltages U required to generate enough electric field E (where E=U/D) to reorient LC molecules. This limitation is related to the electrical power consumption of the device which is proportional to the square of the voltage applied to the device. For example, FIG. 1b demonstrate a case, where, instead of increasing the L, the top electrode layer is shifted further to keep the ratio R optimal (for a given CA), but further are these electrodes higher will be the voltage to drive the device.

This is the reason why we cannot use the «fringing field» approach for relatively large values of CA, e.g., in the range from 0.1 mm to 10 mm, or specifically, in the range from 0.5 mm to 5 mm, used for imaging, ophthalmic and augmented reality applications. It may be useful to notice that such TLCLs or LC gradient index (LC-GRIN) lenses can generally be characterized as having an optical power that is inversely proportional to the aperture CA. In some optical imaging systems, the aperture must be much larger. Thus, the traditional LC-GRIN lens can not provide a noticeable optical power variation range. This is limiting the application of these devices in systems with large CA. Solutions have been proposed to increase the optical power at larger apertures in LC-GRIN lenses, such as to have the same lens operate as a both negative lens and then as a positive lens. However, the clear aperture size requirements remain still a problem if we try to generate a tunable lens over the entire CA.

Various solutions have been proposed to build devices with millimetric range of CA. One approach uses a high resistivity or weakly conductive layer (WCL) next to the HPE to help further propagate the fringing field towards the center of the device (Kahn, F., Electronically variable iris or stop mechanisms. 1973, US patent; Loktev, M. Y., et al., Wave front control systems based on modal liquid crystal lenses. Review of scientific instruments, 2000. 71(9): p. 3290-3297), FIG. 2. However, for millimetric size CAs, the sheet resistance value Rs for such a layer is in the Mega Ohm (per square) region and it is extremely difficult to produce uniform layers with such Rs in a reproducible way and to insure that they are environmentally stable (since very often a non-stochiometric/incomplete oxidation of metals must be maintained to obtain such Rs values).

The use of a number of individually-driven (FIG. 3a) or resistively interconnected (FIG. 3b) concentric ring electrodes has been proposed without the use of any WCL, however, this design leads to some aberrations at the connection points for each ring electrode and can result in artifacts due to the steps in electric field caused by the discrete ring electrodes.

Capacitive coupling between ring electrodes has also been proposed to simplify the drive of the electrodes by providing a single drive signal in the absence of any resistive interconnection to thus remove the aberrations at the connection points. This is taught in U.S. Pat. No. 9,201,285. With capacitive coupling, the gaps between the ring electrodes are covered by coupling electrodes at different levels (two electrode layers being separated by a dielectric isolation layer), such that the electric field gradient is smaller than in the case of discrete concentric ring electrodes that provide zero-potential gaps between the rings. However, this design is more difficult to build and can still lead to some artifacts due to the steps in electric field caused by the electrode structure.

In U.S. Pat. No. 8,421,990, there is taught that a spiral electrode can be arranged for a circular lens in which the resistance of the spiral electrode can be used over its length to reduce voltage, thus providing a suitable electric field spatial distribution over the aperture, and without needing to provide any WCL. Provided that the spacing or pitch between turns of the spiral electrode are small enough, the artifacts due to the steps in electric field caused by the discrete turns of the spiral electrode can be insignificant. However, as described in this patent, the ITO stripes must be strongly spaced generating discrete field transitions, light scattering, and lens quality degradation for millimetric lenses. Thus, such an approach will require the use of a transparent electrode having rather high resistance or small enough pitch for this approach to be suitable for millimetric lenses, both requirements remaining significant challenges (see hereafter).

Another approach to resolving the problem of using a high resistance layer (or WCL) associated with a hole-patterned electrode for creating a spatial distribution of voltage was proposed in the paper titled “Liquid crystal multi-mode lenses and axicons based on electronic phase shift control” by Andrew K. Kirby, Philip J. W. Hands, and Gordon D. Love, published in Optics Express, Vol. 15, No. 21, 17 Oct. 2007. In this paper, an ITO film is placed on the surface of one substrate and used in conjunction with two strip electrodes placed on opposed sides of the substrate and driven by phase-shifted voltages. The use of different phases of drive signals applied to the strip electrodes has been found to create a spatial distribution of voltage when the opposed electrode is grounded such that the arrangement produces a cylindrical lens between the strip electrodes. As reported in the paper, when the opposed substrate also has orthogonally arranged strip electrodes (rotated at 90 degrees with respect to the previous strips), a second pair of driving voltages can be used to create a combination of cylindrical spatial distribution of electric fields that provide for a tunable lens. However, given that signals of opposed phase (e.g., +5 V and −5 V) are simultaneously applied at the opposed edges of a conductor, significant current flows through the uniform ITO increasing dramatically the power consumption of the device.

In the paper by Algorri and Love, a WCL is added to a similar lens design that provides for a lens without the use of phase shifted drive signals. However, this approach re-introduces the problem of needing a WCL. Like the earlier Love's paper, it has the problem that the desired spatial profile of the electric field over the aperture is difficult to maintain since it is dependent on a uniform layer of ITO or WCL.

Liquid crystal optical devices are known in the art that dynamically modulate beams. For example, PCT patent application publication WO2017/040067 published on 16 Mar. 2017 describes a variety of optical arrangements including liquid crystal devices that will broaden a beam. In PCT patent application publication WO2016/082031 published on 2 Jun. 2016, a variety of optical arrangements including liquid crystal devices are described for steering a beam. And in PCT patent application publication WO2018/152644 published on 30 Aug. 2018, a variety of optical arrangements including liquid crystal devices are described for modulating a headlight beam. These devices are all arranged to act on a whole beam.

### SUMMARY

Applicant has discovered that the problem of electric field discontinuity due to a discrete electrode arrangement in an LC-GRIN (or TLCL) optical device having a stepped voltage distribution in space can be solved by the use phase shifted drive signals while using discrete shaped electrodes or by the use of a relatively high dielectric constant layer (HDCL), placed near the stepped electrode, which can “smoothen” the electric potential profile and reduce the artifacts due to the steps in electric field caused by the discrete turns or steps of the stepped electrode. Such HDCLs may be fabricated much easier compared to WCLs (some examples of suitable HDCL materials can be found in the article titled “High dielectric constant oxides” by J. Robertson, published on 2 Dec. 2004 in The European Physical Journal—Applied Physics). Examples of stepped electrode designs are found in the previously mentioned prior art and can include different designs as disclosed hereinbelow. While most polymers and glass have a dielectric constant e in the range of 4 to 6 (air has a dielectric constant of 1), it has been found that transparent materials having a dielectric constant of about e=20 or greater can be applied to the discrete (stepped) spiral or serpentine shaped electrodes with the effect that the resulting electric field does not cause the LC to exhibit artefacts caused by the spatial steps in the voltage of the electrode. An alternative “smoothening” effect can be obtained also if we apply phase shifted signals to the opposed edges of these discrete electrodes. The combination of both approaches can be even more beneficial.

The use of an HDCL can likewise be used also with a network of capacitively-coupled electrodes with a similar “smoothening” effect, while the discretization in this case may be of less importance, making even possible the use of capacitively coupled electrodes with appropriate modifications and without the HDCL, in applications and embodiments we shall describe hereafter.

In one example, Applicant used a coating of Ti₃O₅, cast on a suitably shaped ITO electrode spiral. The Ti₃O₅ layer was 100 nm thick in the example. Such a coating demonstrated significant improvement in the electric potential's profile to make the transmitted light wavefront's modulation soft enough to be acceptable for imaging applications. Other solid material candidates (for the HDCL) may be other metal oxides, such as Hafnium Oxide (HfO₂), Ta₂O₅, ZrO₂, etc.

The case of HfO₂ is particularly interesting and useful since, in addition of having e=20, it also has a refractive index that is very close to the refractive index of ITO. This may enable the fabrication of index matched layers (by optically “hiding” the ITO pattern) that would minimize Fresnel reflections and diffraction from the combined layer of the ITO and HDCL.

In some embodiments, an LC-GRIN cell device has two opposed substrates containing liquid crystal material with a uniform electrode arrangement on a first one of the substrates and a stepped electrode arrangement and a HDCL, placed near the stepped electrode arrangement, on a second one of the substrates.

In some other embodiments, an LC-GRIN cell device has opposed substrates of the second type; that is, the first substrate has a stepped electrode arrangement and an HDCL and a second stepped electrode and an HDCL are present also on the second substrates.

In some other embodiments, the above-mentioned LC-GRIN devices may be built without the HDCL and driven with specific phase shifted electrical signals to smoothen the electric field's profile (by averaging in time).

The device can include an alignment structure, film or layer, so that the liquid crystal is well-aligned in a ground state, such as a rubbed surface coating for planar alignment or homeotropic substrate bonding for homeotropic alignment. Stepped electrode arrangements can include continuous spiral, continuous or discontinuous serpentine electrodes, capacitively coupled segments or rings, individually driven electrode rings or segments, etc. The device can be a circular or cylindrical lens, a beam steering device or a beam broadening or scattering device.

Applicant has further discovered that the problem of providing an electrode arrangement that will produce a desired electric field spatial distribution in an LC-GRIN lens can be solved by linear stepped electrode arrangements provided on opposed substrates of a liquid crystal cell and oriented orthogonal to each other. In such a design, each arrangement of electrodes on each substrate provides a cylindrical lens electric field distribution and the combination of the two arrangements (driven appropriately with phase shifted signals and averaged in time) yields a suitable spherical lens distribution. The desired LC spatial distribution can be controlled by the arrangement of electrodes, for example the spacing of the electrode segments, resistance or capacitive coupling between segments, the thickness of the liquid crystal layer, its dielectric parameters, etc. will influence the shape of the electric field generated.

Unlike WCL coated hole-patterned electrodes whose electric field is difficult to control precisely over the device aperture, orthogonally-arranged, opposed linear stepped electrode arrangements can be printed or laid-out to have a desired voltage drop across the aperture. Unlike individual powering of concentric ring electrodes for a circular lens, drive signals can be supplied to the stepped electrodes from outside the aperture without creating cut-line artefacts.

In some embodiments, an LC-GRIN lens device has opposed substrates (containing liquid crystal) with linear stepped electrode arrangements provided on opposed substrates orthogonal to each other. The device can include an alignment structure so that the liquid crystal is ordered in a ground state, such as a rubbed surface coating for planar alignment or homeotropic substrate bonding for homeotropic alignment. Stepped electrode arrangements can include continuous serpentine electrodes, capacitively coupled segments or rings, individually driven electrode segments, etc.

Applicant has further discovered that the problem of providing good optical power of an LC-GRIN lens in an optical system having a large aperture can be solved by providing an LC-GRIN lens device with an electrode arrangement that permits the formation of a lens at a variable position within the entire optical window of the lens device. While LC-GRIN lenses with segmented circular electrodes are known that can have an optical axis that is slightly (significantly less than the diameter of the lens) moved by adjusting voltages applied to segmented electrodes for the purposes of optical image stabilization, the selective powering of different segments of an electrode arrangement to have a lens move (more than its diameter) is not known in the art. Indeed, such selective powering can be used to move a lens within the device by a distance greater than the radius of the lens and typically greater than the diameter of the lens. It can also be used to change the size of the lens and its profile to generate various forms of desired aberrations, an axicon, a prism, a cylindrical lens, Powell lens, etc. It is important to mention that the anamorphic (or Matrix, or Foveal) lens design disclosed herein allows for almost any desired waveform to be created, including positive and/or negative, circular and/or cylindrical lenses, prisms, axicons, etc.

In some embodiments, an LC-GRIN lens device with an electrode arrangement that permits the formation of a lens at a variable position within the lens device that has linear electrode arrangements provided on opposed substrates orthogonal to each other that can be individually powered to define the location of the formation of the lens, wherein the electric field provided by each linear electrode arrangement on each substrate allows for the formation of a cylindrical variation in the electric field, the combination of which can be used to form a circular lens when the electrical drive signals are phase shifted. The device can include an alignment structure so that the liquid crystal is ordered in a ground state, such as a rubbed surface coating for planar alignment or homeotropic substrate bonding for homeotropic alignment. The strip electrode arrangements can include thin strips only, or thin strips laid on a high dielectric constant layer or a weakly conductive layer or highly resistive layer, continuous serpentine electrodes, capacitively coupled segments or rings, individually driven electrode segments, etc.

Such a lens device can form one or simultaneously multiple lenses having a diameter of about 0.5 mm to about 5 mm, with positioning of the lens within the full aperture of the device being from about every 0.1 mm to about every 1 mm. The total size of the device (the optical window within which the above-mentioned lens can be created and shifted) is not essentially limited except by the application; for example, it can be several centimeters large if needed.

Furthermore, the driving of the above-mentioned millimetric lenses may be achieved either by applying a continuous sequence of signals or may be time sequenced (as it is done in traditional liquid crystal display industry) to obtain “local” responses over the desired coordinates (positions) on the surface of above-mentioned large (multiple centimeter sized) device. Indeed, as it is well known in the traditional liquid crystal display industry (see, e.g., P. J. Collings and J. S. Patel, Handbook of Liquid Crystal Research, Oxford University Press, 1997), the application of time sequenced electrical signals to various electrode contacts will enable the generation of the lens effect mainly in desired (restricted in space) areas of the entire optical window, keeping the rest of the window almost unchanged.

In the application of such an LC-GRIN lens device in panoramic or fish-eye cameras, a movement detection can be incorporated to enable the identification of a specific area of the tunable LC-GRIN lens to be activated enabling, for example, the increase of resolution or modulation of distortion in specific desired direction, e.g., for surveillance purposes, etc.

In the ophthalmic distance accommodation or virtual reality application of eyeglasses, such an LC-GRIN lens device can be controlled to cause a near focus/far focus lens to appear at a location defined by the direction where the user is looking. The eyeglasses can include an eye-tracking device so that the lens can be caused to appear in a direction of viewing. Eye-tracking of each eye can be used to determine the direction and the focal depth for the purposes of determining a desired optical power of the tunable lens. While such eyeglasses can require electrical power, programmable eyeglasses can be provided that may be used in addition to prescription lenses or that may replace prescription lenses. Such corrective lenses can correct for astigmatism, myopia and/or presbyopia. The remote control of drive parameters can allow doctors to adjust and optimize the performance of such glasses during an ophthalmic check-up. When such eyeglasses provide two spaced-apart LC-GRIN devices, two lenses can be caused to appear before the user's eyes such that magnification (optical zoom) of the image can be provided.

Applicant has also found that there is a need to controllably modulate a portion of a beam so as to reduce the light brightness in the portion (in a specific angular range), while leaving a remainder of the same beam unmodulated. Such a need existing both for beam transmission (e.g., in automotive industry for safe driving) as well as for receiving or collecting a beam of light (in Lidars, sensors of simply in photographic imaging).

Liquid crystal optical devices are disclosed that allow for light modulation to be selectively controlled within a portion of an aperture of the liquid crystal modulator and/or that have an improved spatial modulation of the electric field using electrodes that provide shifted or decaying voltages.

### BRIEF DESCRIPTION OF THE DRAWINGS

The present examples will be better understood with reference to the appended illustrations which are as follows:

FIG. 1a illustrates a schematic side view of a lens-type device known in the art, having one substrate covered by a uniform transparent electrode and a second one has a hole patterned electrode (HPE), both electrodes being inside of the sandwich.

FIG. 1b illustrates a schematic side view of a lens-type device known in the art having a top electrode HPE layer shifted away (to the external side of the cell) to keep an optimal ratio R between the diameter of the lens CA and the separation of electrodes D by having electrodes spaced apart.

FIG. 2 illustrates a schematic side view of a lens-type device known in the art having a high resistivity or weakly conductive layer (WCL) to help further propagate the fringing field towards the center of the device.

FIG. 3a illustrates a schematic top view of a lens-type device known in the art having multiple concentric electrodes each of them being individually controlled.

FIG. 3b illustrates a top view of a lens-type device known in the art with concentric electrodes, some of them being individually controlled, while others having resistive bridges.

FIG. 4 shows a schematic top view of a voltage divider trans-line liquid crystal lens known in the art having ITO transmission lines and ITO side electrodes.

FIG. 5a shows a schematic top view of a liquid crystal lens device known in the art having a spiral ITO electrode with one control electrode (external contact) on one of its surfaces.

FIG. 5b is an experimental micro photography of the lens with spiral shaped ITO showing the light scattering and degradation of its wave front due to the discontinuities of the electric field between ITO electrodes shown in FIG. 5a.

FIG. 6a illustrates a schematic top view of a lens with spiral shaped ITO electrode having additionally a relatively high dielectric constant layer (HDCL) in accordance to an embodiment of the present disclosure.

FIG. 6b illustrates a schematic side view of the lens shown in FIG. 6a.

FIG. 6c is an experimental micro photography of the lens with spiral shaped ITO electrode having a HDCL, shown in FIG. 6a, demonstrating the softened phase modulation.

FIG. 7a illustrates a schematic top view of a spiral shaped ITO electrode optionally having a relatively high dielectric constant layer (HDCL) wherein the substrate has an electric via in the center of the top substrate allowing a second electric contact from the opposite side of that substrate in accordance to an embodiment of the present disclosure enabling phase shifted drive (PSD) as well as bipolar (positive or negative optical power) operations.

FIG. 7b illustrates a schematic side view of the electrodes shown in FIG. 7a.

FIG. 8a illustrates a schematic top view of a spiral-shaped electrode in accordance with one embodiment of the present disclosure having an ITO pattern allowing a second (inner or central) contact on the same substrate enabling PSD as well as bipolar (positive or negative optical power) operations.

FIG. 8b illustrates a schematic top view of an electrode in accordance with one embodiment of the present disclosure having an ITO pattern allowing the control of two segments (internal and external) for a Refractive-Fresnel type operation.

FIG. 8c illustrates a schematic top view of an electrode in accordance with one embodiment of the present disclosure having an ITO pattern with an Archimedean spiral enabling PSD operations.

FIG. 9a illustrates a schematic side view of a cylindrical lens-type device known in the art, having a PSD wherein the bottom substrate is grounded, and the top substrate has two contacts at the opposed corners and the voltages providing a phase shifted at P.

FIG. 9b illustrates a schematic side view of a cylindrical lens-type device known in the art, having a PSD wherein the bottom substrate is grounded and the top substrate has two contacts at the opposed corners and the voltages providing an adjustable phase shift ((p) and bias voltage.

FIG. 10a illustrates an exploded view of an array of 2×2 lenses as known in the art, wherein the PSD is implemented by using parallel linear (finger like) electrodes and high resistivity or WCL layer.

FIG. 10b illustrates an exploded view of the array of 2×2 lenses shown in FIG. 10A wherein two electrodes at each extreme corner are shorted and driven with the same voltage and phase.

FIG. 11a illustrates a schematic top view of a substrate having a linear or serpentine-shaped electrode stripes or lanes with an optional HDCL in accordance to an embodiment of the present disclosure.

FIG. 11b illustrates a diagram schematically showing the changes of electrode potential (U1) for two contacts (shown in FIG. 11a) when they are driven with phase-shifted and biased potentials, both are driven, one of them is grounded or floating.

FIG. 12a illustrates a schematic top view of a top substrate, having an optional HDCL and contact 1 and contact 2, used in an LC cell along with another substrate containing a similar or uniform electrode enabling both steering and focusing functions in accordance with an embodiment of the present disclosure, wherein contact 1 and contact 2 are separated at the top.

FIG. 12b illustrates a schematic top view of a bottom substrate, having an optional HDCL and contact 3 and contact 4, which can be combined with the top substrate to form an LC cell that can perform both steering and focusing functions in accordance (with an appropriate PSD) with an embodiment of the present disclosure, wherein contact 3 and contact 4 are separated at the bottom.

FIG. 12c illustrates a schematic top view of an LC cell that can perform both steering and focusing functions (with an appropriate PSD) in accordance with an embodiment of the present disclosure, wherein two substrates, shown in FIGS. 12a and 12b, are assembled together with corresponding contacts 1 to 4.

FIG. 13a illustrates an example of experimentally observed distribution of the output light's wave front (observed between cross oriented polarizers), obtained with the proposed cell design presented in FIG. 12c, but without HDCL.

FIG. 13b is a plot of voltage as a function of time (in ms) for control signals applied to electrodes on opposed substrates.

FIG. 14a illustrates a schematic top view of a top substrate of an LC cell allowing the generation of a lens with different apertures (diameters) and positions (centers) having two similar substrates as shown in FIG. 12a, but with multiple electrode contacts (juxtaposition of multiple similar patterns) in accordance with one embodiment of the present invention.

FIG. 14b illustrates a schematic top view of a bottom substrate of an LC cell allowing the generation of a lens with different apertures and positions having two similar substrates as shown in FIG. 12b, but with multiple electrode contacts (juxtaposition of multiple similar patterns) in accordance with one embodiment of the present invention.

FIG. 14c illustrates a schematic top view of an LC cell allowing the generation of a lens with different apertures and positions in accordance with an embodiment of the present disclosure, wherein two substrates shown in FIGS. 14a and 14b are assembled together with corresponding contacts 1 to 8, as example.

FIG. 14d illustrates few examples of various levels of optical power in a single unit of the proposed device in FIG. 14c wherein the sample is placed between two cross oriented polarizers with the LC director oriented by the diagonal at 45 deg.

FIG. 14e illustrates the use of the same device, illustrated in FIG. 14c, to create larger aperture lenses and to shift its center.

FIG. 15a illustrates an embodiment of the present disclosure wherein the ITO pattern parameters of electrodes of FIG. 14a as well as the parameters of the liquid crystal cell and of the electrical drive signals are adjusted to obtain a symmetric linear drop of potential and generate cylindrical lens arrays.

FIG. 15b illustrates an embodiment of the present disclosure wherein the continuity of electrodes is disrupted into segments or zones with two contacts for each segment and the ITO pattern parameters as well as the parameters of the liquid crystal cell are adjusted to generate asymmetric drops of the electric potential to generate prism arrays.

FIG. 16a illustrates a back view of a pair of ophthalmic glasses for day to day use, augmented reality use or other specific use having a built-in lens and eye tracking capable of focusing and adjusting unpolarized light (e.g., a combination of two cross oriented lenses, proposed in FIG. 14c, to insure polarization independent operation) in accordance with an embodiment of the present disclosure.

FIG. 16b illustrates a side view of a pair of ophthalmic glasses (similar to the one presented in FIG. 16a) having liquid crystal lens arrays on both sides of the eye glass enabling enhanced vision (focusing and zooming) capabilities.

FIG. 16c shows a schematic block diagram of the eyeglasses shown in FIG. 16b.

FIG. 17a schematically shows a basic device enabling the generation of dark zones (dip of light power) on the transmitted beam's transversal distribution by the formation of refractive index modulation in specific areas of interest of the matrix lens.

FIG. 17b schematically shows the device of FIG. 17a and the segment of interest (in the matrix lens) in its ground (non excited) state providing the original light distribution.

FIG. 17c schematically shows the device of FIG. 17a and the segment of interest (in the matrix lens) in the excited state providing the light distribution with the dip of intensity (the dark window or zone of desired shape).

FIG. 18a schematically shows a top substrate with linear individually controlled discrete electrodes.

FIG. 18b schematically shows a bottom substrate with a uniform transparent electrode.

FIG. 18c schematically shows (top view) a combination of top (FIG. 18a) and bottom (FIG. 18b) substrate to form a liquid crystal cell with the capability of creating local excitation zones.

FIG. 19a schematically shows (side view) a combination of top (FIG. 18a) and bottom (FIG. 18b) substrate to form a liquid crystal cell with the capability of creating local excitation zones.

FIG. 19b schematically shows (side view) a possible variation of the device of FIG. 19a when the top substrate contains also a weakly conductive layer.

FIG. 19c schematically shows (side view) a possible variation of the device of FIG. 19a when the top substrate contains also a uniform transparent electrode that is separated from the original linear electrodes by a preferably thin dielectric isolation layer to provide accelerated operation mode.

FIG. 20a schematically shows a bottom substrate with linear individually controlled discrete electrodes oriented at 90 degrees with respect to the electrodes described in FIG. 18a.

FIG. 20b schematically shows (top view) a combination of top (FIG. 18a) and bottom (FIG. 20a) substrates to form a liquid crystal cell with the capability of creating local excitation zones.

FIG. 21a schematically shows the combination of two identical sandwiches with liquid crystal orientations being perpendicular.

FIG. 21B schematically shows the combination of two identical sandwiches with the same orientation of liquid crystal but with a polarization rotation element (e.g., a half wave plate or HWP).

FIG. 22A schematically shows the combination of the above-mentioned dark zone generation device combined with a light source, a primary light-conditioning (e.g., collimating) optics and a diaphragm.

FIG. 22B schematically shows the combination of the above-mentioned dark zone generation device combined with a light detection unit.

FIG. 22C schematically shows the combination of the above-mentioned dark zone generation device combined with multiple light sources and along with multiple primary light-conditioning (e.g., collimating) optics.

FIG. 22D schematically shows the combination of the device of FIG. 22A combined with an electrically tunable lens or lens array.

FIG. 23A schematically shows the automotive application of the described-above devices when multiple (co- and counter-propagating) cars are present on the road.

FIG. 23B schematically shows the sensing application of the described-above devices when multiple (including one powerful) sources are present on the screen.

FIG. 23C schematically shows the image capturing application of the described-above devices when a powerful local light source is present on the screen.

FIG. 24A schematically shows the generation of a horizontal dark line.

FIG. 24B schematically shows the generation of a circular dark zone.

FIG. 24C schematically shows the simultaneous generation of a circular dark zone and a vertical dark line.

FIG. 25A shows the simulation results for an unperturbed light beam with approximately gaussian shaped intensity (transversal) distribution.

FIG. 25B shows the simulation results for the narrow dark line passing through the center of the light beam.

FIG. 25C shows the numerical values obtained for the case demonstrated in FIG. 25B.

FIGS. 26A, 26B and 26C illustrate the simulated beam intensity in the Y axis at screen distances of 1.5 m, 3.5 m and 5.0 m respectively.

FIGS. 27A to 27D show how the choice of the diameter (0.05 mm, 0.25 mm and 0.5 mm for FIGS. 27A to 27C respectively) of the activated cylindrical microlens of the matrix lens.

FIGS. 28A to 28C illustrate on the left side the beam intensity image and on the right side the corresponding beam intensity along the Y axis for the case of the focal distance of the microlens chosen to be −2.0 mm, −5.0 mm and −0.5 mm, respectively.

FIGS. 29A to 29C illustrate plots of the light distribution pattern for the choice of the focal distance (−50 mm, 50 mm and 75 mm, respectively) of the imaging lens.

FIG. 30 is a block diagram of a dark zone matrix device having controllers for strip electrodes.

FIG. 31 is an illustration of an optical arrangement including a matrix element, an imaging lens and a screen.

FIG. 32A shows the image of the transmitted beam in the ground state (0V).

FIG. 32B shows the image of the beam at 10V.

FIG. 32C shows the intensity distribution across the beam on the screen versus applied voltage.

FIGS. 33A to 33F show images using two simultaneously generated cylindrical micro lenses that generate two dark zones in corresponding angular zones.

### DETAILED DESCRIPTION

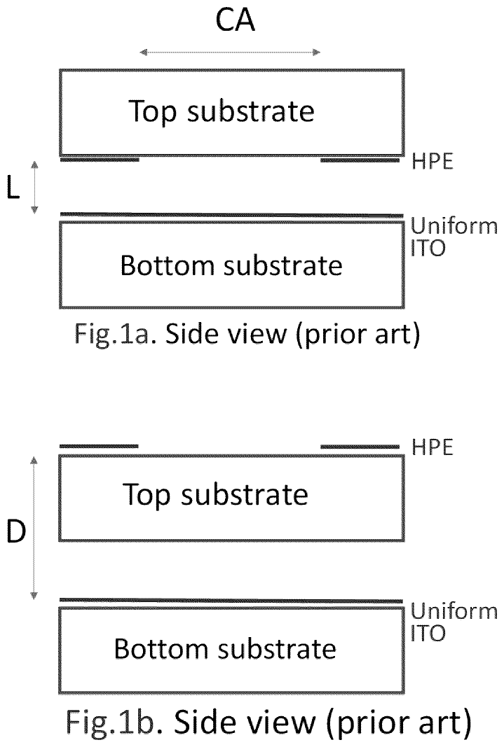

FIG. 1a schematically demonstrates an electrically variable LC lens that is built by using a patterned (circular, to obtain a lens, or linear, to obtain a prism) electrode on one of the substrates of a sandwich device containing the LC material. The second substrate of the sandwich is typically covered by a uniform transparent electrode (indium tin oxide or ITO). In the case of a circular lens, the first electrode is hole patterned electrode (HPE).

In this case, the electric field is strong in the periphery of the lens (where the HPE is facing closely the uniform ITO electrode) and is decreasing gradually when we consider positions closer to the center of the device (far from the HPE's internal limit). The reaction of the LC and the corresponding profile of the refractive index gradient will be defined by the ratio R of the clear aperture CA over the separation of electrodes D (in FIG. 1a, we have used D=L, where L is the thickness of the LC layer). It was shown that the desired order of magnitude of R is 2.5.

The above-mentioned approach can be successful in a very narrow range of CA. However, there are several limitations in the case of millimetric ranges: to maintain good optical aberrations, the thickness L of the LC must be increased. However, larger L provides stronger light scattering and longer relaxation times. We could alternatively increase D, but it will increase the electrical power consumption. FIG. 1b demonstrate such a case, where, instead of increasing the L, the top electrode layer is shifted further to keep the ratio R optimal (for a given CA).

This is the reason why we cannot use the «fringing field» approach for relatively large CA values, e.g., in the range from 0.1 mm to 10 mm, or more specifically, in the range from 0.5 mm to 5 mm, used for imaging, ophthalmic and augmented reality applications.

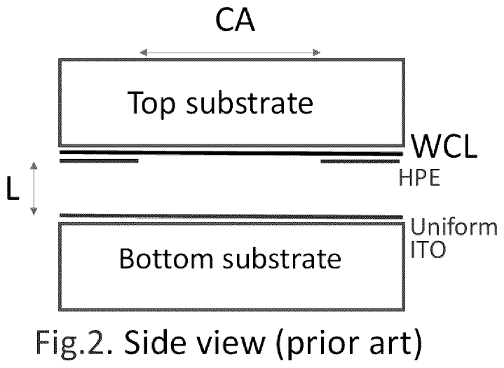

Various solutions have been proposed to build devices with millimetric range of CA. One approach uses a high resistivity or weakly conductive layer (WCL) to help further propagate the fringing field towards the center of the device (Kahn, F., Electronically variable iris or stop mechanisms. 1973, US patent, Loktev, M. Y., et al., Wave front control systems based on modal liquid crystal lenses. Review of scientific instruments, 2000. 71(9): p. 3290-3297), FIG. 2. However, for millimetric size CAs, the sheet resistance value Rs for such a layer is in the Mega Ohm (per square) region and it is extremely difficult to produce uniform layers with such Rs in a reproducible way and to insure that they are environmentally stable (since very often a non-stochiometric/incomplete oxidation of metals must be maintained to obtain such Rs values).

Given that the main challenge (for obtaining the desired profile of electric potential) is related to the design of the substrate with non-uniform (e.g., hole patterned) electrode, we shall further consider various (known and new, proposed here) versions of it (which we could call a «control substrate»), keeping in mind that, usually, we need the opposed substrate also to obtain the final device.

The fabrication of ITO layers is currently well mastered in the industry (see hereafter). Thus, several approaches were proposed to use patterned ITO (without the WCL) to obtain the required gradient of the electric field.

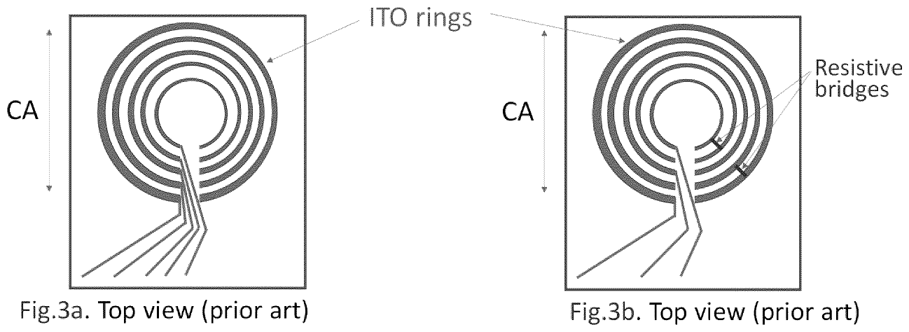

Thus, one of them uses multiple very closely positioned discrete (up to 80) circular electrodes (Li, L., D. Bryant, and P. J. Bos, Liquid crystal lens with concentric electrodes and inter-electrode resistors. Liquid Crystals Reviews, 2014. 2(2): p. 130-154), which are controlled individually (like in LC displays, FIG. 3a) or are partially resistively bridged (FIG. 3b). While the use of bridged electrodes reduces the number of individually controlled electrodes, this is still a very costly and complex (both for manufacturing and operation) solution.

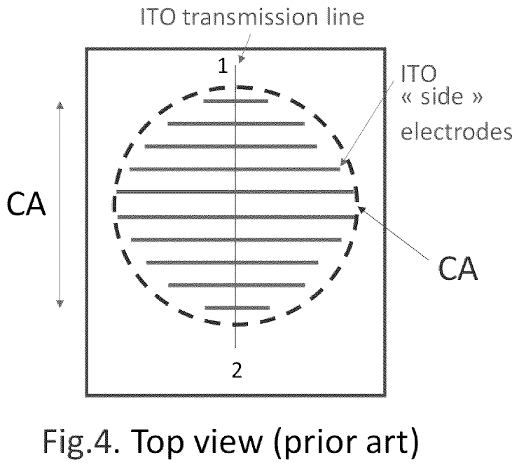

An alternative technique of using extremely narrow ITO as a very resistive «transmission line» (and phase shifted driving technique) was suggested (J. F. Algorri, N. Bennis, V. Urruchi, P. Morawiak, L. Jaroszewicz, J. M. Sanchez-Pena, Voltage divider trans-line liquid crystal lens, PC20, 15th European Conference on Liquid Crystals, FIG. 4) to propagate the electric potential further towards the center of the device in the desired way (by distributing different values of the electrical potential from the center to the periphery). However, if the resistance of the transmission line is not high enough, the only way to create a spatial profile of electric field will be the “forced” or phase shifted control. In contrast, to obtain a “natural” decrease of the potential (e.g., when one of the contacts is powered, while the second one is floating) for millimetric range devices, the width of a standard ITO «transmission line» (with a Rs value between 50 to 100 Ohm/square) must be sub micrometric, which is extremely difficult to obtain in a reproducible way at the industrial scale. Thus, even for a 0.5 micrometer width of the ITO transmission line, the drop of potential over 10 mm is less than 12%. Thus, the electric potential's modulation depth is very poor.

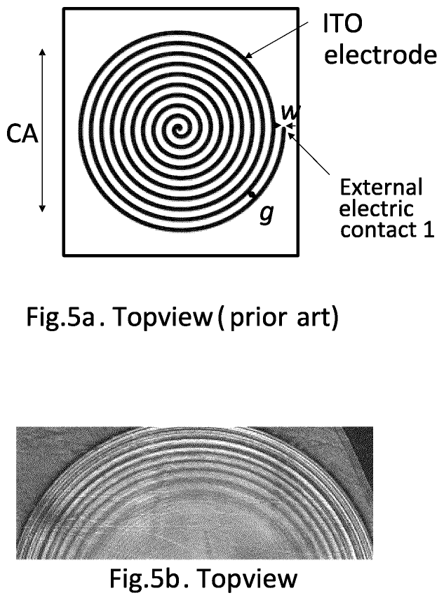

Another approach of a spiral shaped ITO electrode was proposed (in U.S. Pat. No. 8,421,990 B2, FIG. 5a), which seems to be simpler to produce and to control. Indeed, if the parameters of the system are well designed, only one electric signal (with respect to the ground) is needed here to create and to control the lens. The electric potential is applied to the external electric contact 1, while the central end of the ITO is let floating. The opposed substrate bears a uniform transparent electrode that can be grounded.

However, in this approach, to propagate (with gradual decrease) the electric potential to millimetric scales (with typical LC materials, thicknesses of at the order of 50 micrometers), the width w of the ITO lane and the gap g between neighboring ITO lanes must be chosen in a way that the pitch of the ITO pattern (w+g) becomes comparable with the thickness of the LC layer L. In this case, the LC material's reaction will be abrupt (step wise between the zones with and without ITO) since the corresponding fringing field will not be able to «smoothen» the electric field between ITO lanes. This will create light scattering and degradation of its wavefront. This is demonstrated in the photo of FIG. 5b. To obtain this photo, the LC cell (with unidirectionally oriented nematic LC, or NLC, sandwiched between two substrates one bearing a uniform ITO and the second one bearing a spiral shaped ITO) was placed between crossed polarizer and analyzer. Light passing through the polarizer enters into the LC cell and generates two polarization modes (ordinary and extra ordinary). They propagate with different phase delays, which depends upon the position of observation: more the molecules are reoriented less the phase delay is. For a parabolic profile of molecular reorientation, the analyzer will allow the transmission of light or block it depending upon the local phase delay. This generates concentric rings the distance between which is showing the 2π phase delay between the two polarization modes. Thus, the phase profile of light (passing through the lens) is visualized (one half of the device is shown only) here as bright and dark fringes. We can see multiple additional (see hereafter) discrete “mini” fringes due to the above mentioned effect of abrupt changes (FIG. 5b).

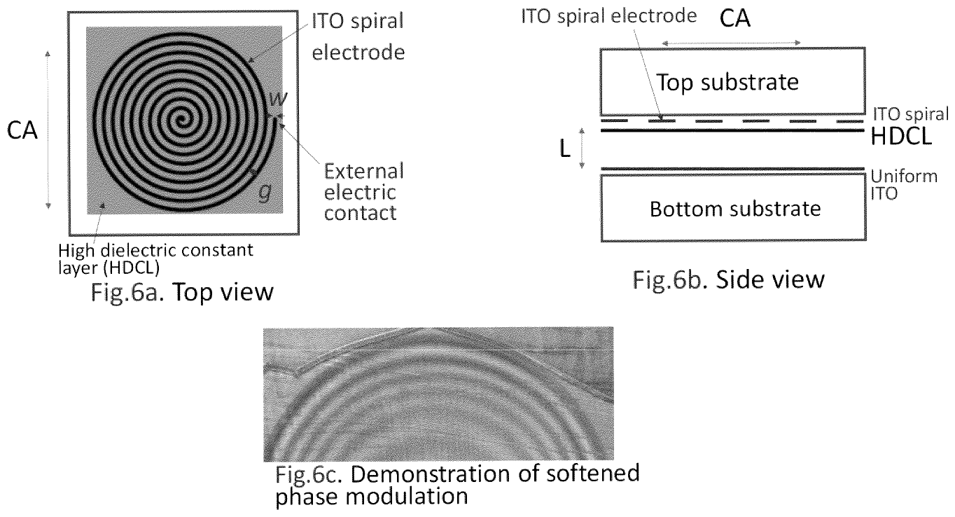

To resolve the above-mentioned problem of wavefront degradation, we propose the use of a relatively high dielectric constant layer (HDCL), including the real, imaginary or both components. The proposed HDCL must be cast near the ITO pattern (e.g., cast under or above the patterned ITO layer, FIG. 6a and FIG. 6b). Its dielectric constant e may preferably be in the range of e=20 or above to be used for the range of CAs we are interested in. As a reference, air has e=1 and most polymers and glass materials have e in the range of 4 to 6.

The experimental verification demonstrates that the proposed HDCL indeed smoothens the electric potential's profile and makes the light wavefront acceptable for imaging applications (see the photo of FIG. 6c, obtained in the same conditions and with the same device as the one shown in the photo of FIG. 5b, but a 100 nm thick Ti₃O₅ was cast on the patterned, spiral-shaped, ITO). In contrast to the WCL, there are many industrially well-mastered optical materials with high e (see, e.g., J. Robertson, High dielectric constant oxides, Eur. Phys. J. Appl. Phys. 28, 265-291 (2004)). Thus, other solid material candidates (for the HDCL) may be other metal oxides, such as Hafnium Oxide (HfO₂), Ta₂O₅, ZrO₂, etc.

The case of HfO₂ is particularly interesting and useful since, in addition of having e=20, it also has a refractive index that is very close to the refractive index of ITO. This may enable the fabrication of index matched layers that would minimize Fresnel reflections from the combined layer of the ITO and HDCL (since the ITO layer will be optically “hidden”).

We can also find some photopolymerizable LC materials which have high e (often they are anisotropic, so e_{II} and e_{⊥} are different and their difference Δe ≡e_{II}−e_{⊥} can be rather high, well above 10).

Thus, in a first embodiment, to obtain millimetric scale devices with gradually changing electric field we propose to use a high dielectric constant material layer in the close proximity to the pattern of the ITO electrodes (under or above).

In a different embodiment, the substrate, that is bearing the ITO spiral, can itself be a material with high value of e.

In a different embodiment, the LC materials can itself be a material with high value of e.

In a different embodiment, the HDCL material can be a combination of layers.

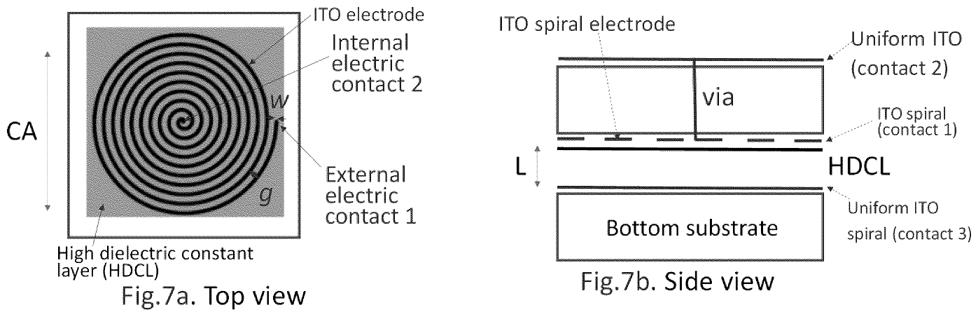

In a different embodiment, the substrate, that is bearing the ITO spiral, can contain a transparent electrode (preferably on its external surface, FIG. 7a and FIG. 7b) that is connected to the central point of the inner spiral electrode (by a via, small hole, etc.). In this case, the application of the high potential to the inner electric contact (here No. 2) will generate stronger field in the center of the device. This will allow to create a lens with inversed optical power (defocusing light instead of focusing). This will allow increasing the dynamic range of optical power variations by creating first positive and then negative lens by the same device (if, e.g., we start by applying high potential at contact 1, then reduce it and then apply high potential on contact 2, etc.).

In another embodiment, PSD signals with various potentials (U₁ and U₂) can be applied simultaneously on contacts 1 and 2 with specific phases (Φ₁ and Φ₂), which will allow the additional re-shaping of the distribution of the electric potential in the transverse plane (containing the spiral) and in the area filled by NLC.

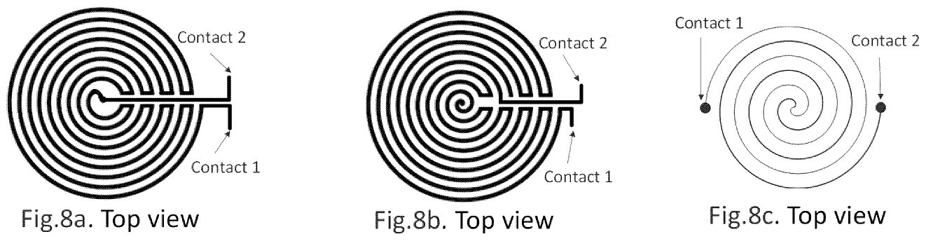

Alternatively, in a different embodiment, the pattern of the ITO spiral may be rearranged in a way to create the second (inner or central) contact on the same substrate, FIG. 8a. The small area used to bring the second contact to the center should be as narrow as possible to avoid the additional degradation of light wave front.

This design also will allow the creation of a bipolar (positive or negative) lens (by respectively providing lower or higher potential to the contact 2, which, in the second case, will generate higher electric field in the center of the lens), and thus enable larger dynamic range of total optical power variation. Indeed, for the same LC layer, we can also obtain a positive lens by applying higher potential to the contact 1 (which will generate higher electric field in the periphery of the lens).

The use of a high dielectric constant material (not shown here only for the sake of simplicity) is optional here, but it can additionally help if applied.

In another embodiment, this “cut-line” approach can be used also to create segmented electrode zones (e.g., 2), similar to refractive Fresnel lenses FIG. 8b. In this case, the contact 1 will control the external zone of the lens while the contact 2 will control the internal zone of the lens. Here also, the use of a high dielectric constant material is optional.

The addition of the second contact in FIG. 8a may also enable the use of various PSD driving techniques, including the case, when, for example, the high voltage is provided to one contact (U₁), while the second one is ground (and U₂=0). The voltage distribution will be different (and thus the properties of the lens will be different) if that second contact is kept «floating» (not ground). Even more interesting here is the case, when we apply different voltages (say, U₁ and U₂) with different phases, Φ₁ and Φ₂.

The same PSD approach of applying different voltages and phases can be used to obtain various potential distribution in another embodiment of this invention where an Archimedean spiral (FIG. 8c) is used to obtain the desired spatial profile of the electric potential. Here also, the use of a high dielectric constant material is optional.

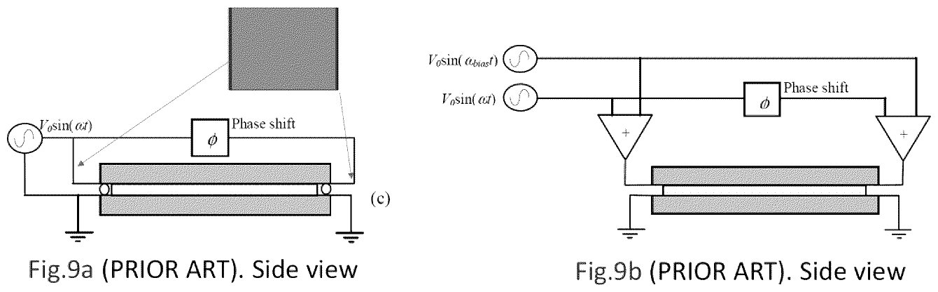

Such a PSD approach has been already demonstrated to obtain lensing effect (Andrew K. Kirby, Philip J. W. Hands, and Gordon D. Love, Liquid crystal multi-mode lenses and axicons based on electronic phase shift control, 17 Oct. 2007/Vol. 15, No. 21/OPTICS EXPRESS 13496). In that demonstration, two substrates are bearing uniform ITO layers. FIG. 9a represents the operation principle in its simplest demonstration, for the case of a cylindrical lens. The bottom substrate here is grounded. The top substrate has two contacts at the opposed corners and the voltages (here sinusoidal), applied to those corners, are phase shifted at p. This phase shift (e.g., for φ=180°), generates a drop of the electrical potential from the periphery of the device (U=6.3V) to the center of the device (U=0V), generating thus a corresponding molecular reorientation pattern. Various modifications of this device are possible, including the change of p and/or adding a bias voltage FIG. 9b,

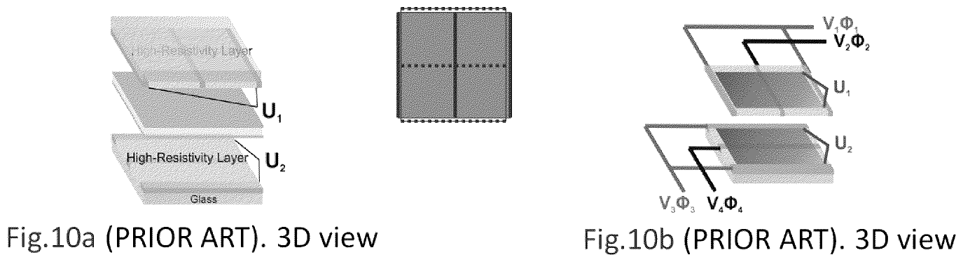

In another article (J. F. Algorri, G. D. Love, and V. Urruchi, Modal liquid crystal array of optical elements, 21 Oct. 2013|Vol. 21, No. 21|DOI:10.1364/OE.21.024809|OPTICS EXPRESS 24809), authors describe a further application of the PSD by using parallel linear (finger like) electrodes and high resistivity or WCL layer (FIG. 10a) to generate arrays of 4 (or 2×2) lenses. In this case, each substrate is bearing 3 ITO (parallel linear) electrodes, but, to construct the cell, the second substrate (with a similar electrode structure) is rotated by 90°. For this purpose, two electrodes at each extreme corner are shorted (FIG. 10b) and driven with the same voltage and phase (V₁ and Φ₁ at the top substrate and V₃ and Φ₃ at the bottom substrate), but the middle electrodes are driven independently with specific voltages and phases (V₂ and Φ₂ at the top substrate and V₄ and Φ₄ at the bottom substrate). The device allows the simultaneous generation of 4 (or 2×2) lenses, that can be controlled by the voltages and relative phase shifts between those electrodes.

There are several problems here, but the most important is the use of WCL since its fabrication is not obvious. However, the role of the WCL is to “re-shape” the electrical potential distribution in the transversal plane. In what we shall propose next, this function can be performed without the use of a WCL.

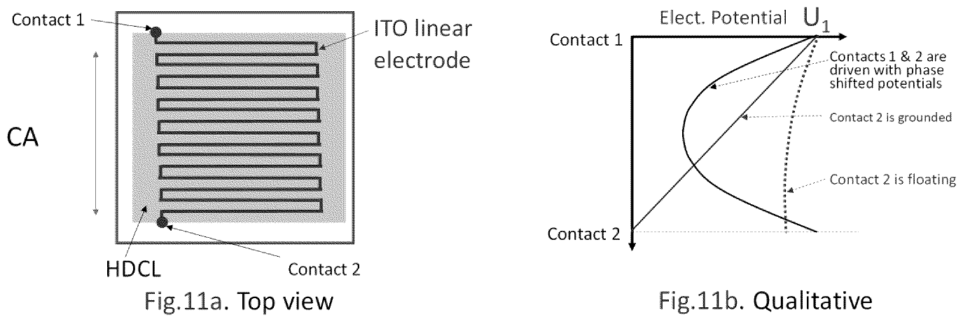

In a different embodiment, the previously described here “circular” spiral pattern of ITO (FIG. 6a) may be replaced by linear-shaped electrode stripes or lanes (FIG. 11a) to generate electrically tunable prism or cylindrical lens functions. Thus, the application of the high electric potential U₁ to the contact 1 will generate stronger LC reorientation on the upper part of the device, since this potential will decrease with different gradients (towards the electric contact 2, see FIG. 11b) depending upon the fact if the contact 2 is grounded U₂=0 (this may generate a rapid drop of potential) or if it is left floating U_{F} (this may generate a slower decrease of the electric potential. Such a substrate, combined with the opposed substrate with uniform grounded ITO (to form a sandwich with NLC) will enable the generation of a transversal gradient of the refractive index and a corresponding tilt of light, e.g., in the direction towards the contact 2 if the NLC has positive anisotropy. The situation may be inversed if the potential is applied to the second contact (bottom).

We can also generate a symmetrical electric potential profile (FIG. 11b) if these two contacts are driven with specific potentials (U₁ and U₂) with specific phases (Φ₁ and Φ₂). This is a particularly interesting case since this type of substrate, combined with a similar substrate (to form a sandwich with first one) that is rotated at 90 degrees (see hereafter) and driven with PSD can be used even without the HDCL.

Here also, many variations of PSD are possible in terms of voltages and phases applied to both contacts (FIG. 11).

In a different embodiment, the width w of the ITO lanes or their pitch (lane separation g) or both of those parameters (w and g) may be spatially varied (chirped) in a linear or non linear way to additionally shape the electric field across the transvers plane of the device (in all previous and following electrode designs). The value of e of the HDCL may be further optimized for these varying patterns of ITO. The dielectric parameters of the LC as well as its thickness must also be taken into account in this optimization.

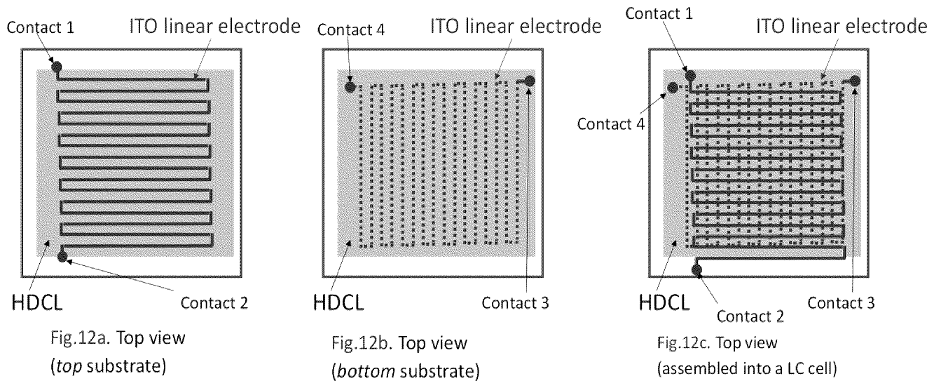

In a different embodiment, as already mentioned above, the combination of two similar substrates (with or without the HDCL) can be used to build a LC cell (or sandwich) that can perform both steering and focusing functions. FIG. 12 demonstrates separately the top (FIG. 12a), bottom (FIG. 12b) and assembled together (FIG. 12c) substrates with corresponding electrodes and 4 electric contacts (two by substrate). The use of the HDCL is not required here.

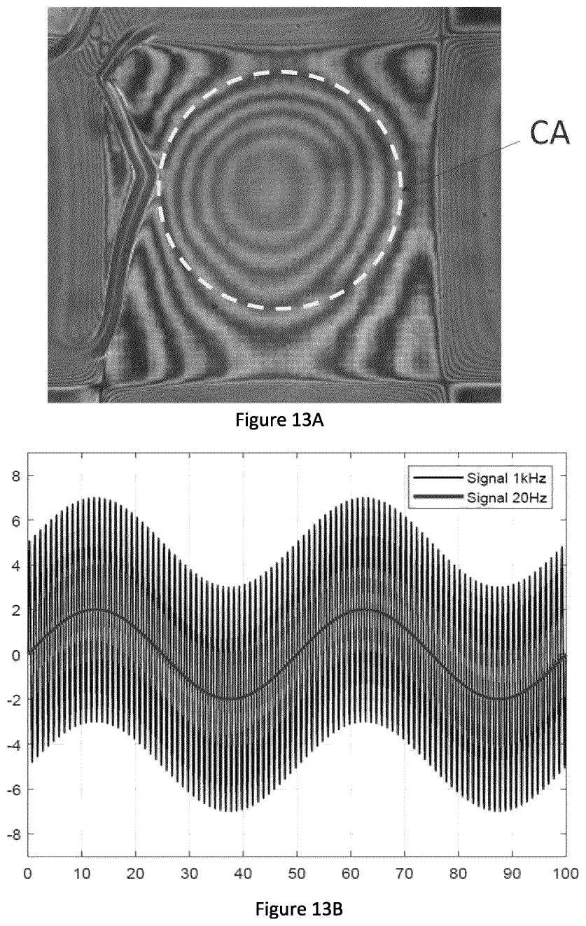

An example of experimental results, obtained with the proposed cell design FIG. 12c (with the top substrate presented in FIG. 12a, and with an opposite substrate presented in FIG. 12b, without the use of HDCL in both cases) is shown in the FIG. 13a. To obtain this figure, the cell was placed between cross oriented polarizer and analyzer, and the ground state orientation of NLC molecules was aligned at 45 degree (along the diagonal). The bright and dark rings represent, respectively, 2π and π phase shifts (between ordinary and extraordinary polarization modes) on the wavefront of light traversing the cell.

The clear aperture diameter of the lens is approximately 0.5 mm and the thickness of the liquid crystal is 40 micrometers (the birefringence of the NLC is ≈0.2). The ground state orientation of the liquid crystal here is by diagonal (at 45 degrees with respect to electrode lines (it can be chosen to be different also). The typical voltage applied on electrodes may be at the order of or below 10V_{RMS} and the typical frequency is 0.5 kHz. The relative phases of 4 signals are 0, 90°, 180° and 270°. This picture shows that the wavefront of light is now curved and light is focused (the dashed white circle shows the useful part of the CA). By changing the control parameters (voltage, frequency, phase shifts, etc.) we can change the focusing distance and aberrations of the lens.

To improve the performance of the lens, we may offset the potential of one substrate with respect to the second substrate. This may be done by using a combination of electrical signals, for example, one high frequency and one low frequency as illustrated in FIG. 13b, on one of couples of electrodes (cast on the same substrate) with respect to other couple of electrodes (cast on the opposed surface). FIG. 13b shows an example of sine waveform, but it can be also square shaped since the liquid crystal reacts to the RMS field.

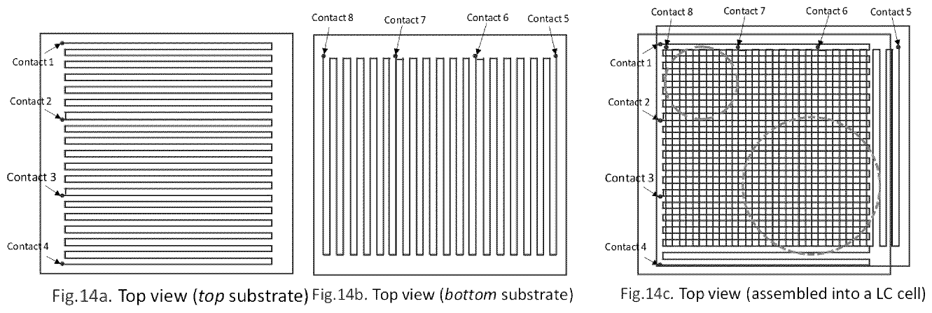

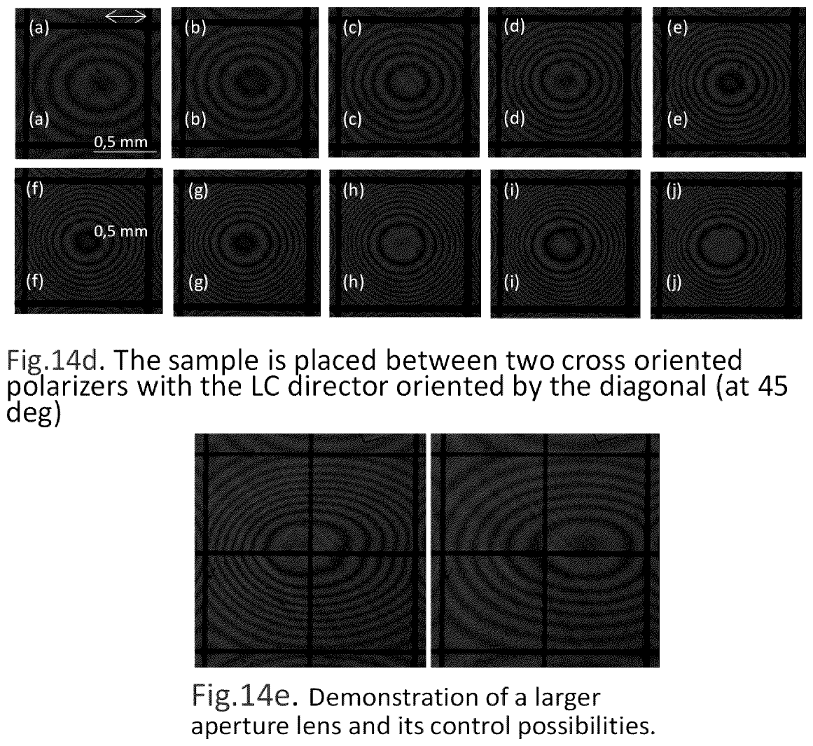

In still another different embodiment, two similar substrates with however multiple electrode “external” contacts (FIG. 14), each segment (between these contacts) being similar to those described in FIG. 12 (with or without HDCL), can be used to build an LC cell allowing the generation of a dynamic lens with different apertures and positions. Namely, we can use a first substrate (FIG. 14a), on which we have multiple segments connected to the driver (just for example, from 1 to 4). Each of these external contacts may be powered (with different voltages in different phases), put to ground or let as floating. Another similar substrate, but with electrodes aligned in the perpendicular direction (FIG. 14b) may be also fabricated. We can then position them together at a specific distance to build the LC cell sandwich (FIG. 14c).

We can then apply continuous sequence of signals or standard LCD time multiplexed signals to various electrode groups as described in FIG. 9-12. For example, if the electrodes 1, 2, 8 and 7 are driven, then, in this case, we can create a lens with a clear aperture described by the dashed circle (top left of FIG. 14c). In contrast, if we apply specific excitations to the electrodes 2, 4, 7 and 5 (while electrodes 3 and 6 are left floating), then we can create another lens in the bottom left corner of the device, and in addition, with a larger CA shown by the large dotted circle (FIG. 14c). Obviously, we can move the center at desire by using the right contacts and right excitation signals.

In the example, described above (in FIG. 14c), the remaining area (out of the “dynamic lens” zone) may appear non uniform or distorted if we do not care about it. However, it may affect the peripheral vision of the customer or affect the quality of the recording if such a lens is used, e.g., in a panoramic (or fish-eye) camera. In this case, we can also apply electrical signals to remaining electrodes to homogenize the liquid crystal orientation in those zones too. For example, if the desired “dynamic” lens is created in the top left corner (by activating the electrodes 1 & 2 and 8 & 7), then the remaining electrodes (3 & 4 and 6 & 5) may be activated by other electric signals to also reorient molecules, but in a flat manner (uniform), not lens-like.

Alternatively, as it is well known in the traditional liquid crystal display industry (see, e.g., P. J. Collings and J. S. Patel, Handbook of Liquid Crystal Research, Oxford University Press, 1997), the application of time sequenced electrical signals to specific electrode contacts will enable the generation of the lens effect mainly in the desired (restricted in the transverse space) areas of the entire optical window, keeping the rest of the window almost unchanged.

Multiple lenses (positive, negative, circular, cylindrical, etc.) can also be created and shifted in different positions simultaneously if desired.

FIGS. 14d and 14e show a few examples of various modes of operations of the proposed device. Thus, FIG. 14d represents the creation of a small lens within a single “unit” (here, 1 mm×1 mm, formed by two pairs of cross oriented electrodes made of chrome/dark lines/to better visualize the position of the cell) and the change of its optical power. Acquisitions were done using interferometric imaging (cell is under crossed polarizer and analyzer) under illumination by a Ne—He laser with a drive signal of (a) 100 Hz, (b) 200 Hz, (c) 300 Hz, (d) 400 Hz, (e) 500 Hz, (f) 600 Hz, (g) 700 Hz, (h) 800 Hz, (i) 900 Hz, (j) 970 Hz. The direction arrow in (a) shows the rubbed alignment direction on the polyimide film (ground state orientation of NLC molecules). It is the same for all of the images. This shows the influence of frequency at the fixed voltage of 2.8V on the performance and optical quality using a test cell having 1 mm diameter (the phase shift here is obtained by slight frequency shift of the corresponding electrical signal). Indeed, we demonstrate here that the lens control may be obtained also by the frequency.

Alternatively, as predicted above, we can use the same device to create larger aperture lenses. An example of such a lens is presented in the FIG. 14e (left). With the appropriate control of driving parameters, we can also shift the center of the lens with respect to the electrode lines (demonstrated in the FIG. 14e, on the right).

In another embodiment, the combination of two above mentioned “control” substrates (with patterned ITO electrodes, instead of one being uniform) is used to build the LC sandwich and obtain electrically variable lenses or prisms.

In another embodiment, the combination of two above mentioned sandwiches is used to build an LC device which has smaller or negligible polarization sensitivity (each sandwich affecting mainly one of two perpendicular polarization of unpolarized light and the final assembly acting like a polarization insensitive device).

Dual frequency, blue phase or other liquid crystal compositions may be used to enhance the performance of the above-mentioned device.

The described above electrodes may be of linear rectangular or other forms. The ITO pattern may be segmented into different zones and those zones can be controlled independently or left floating.

The application of the HDCL may not be necessary in the case when phase shifted signals are applied on linear shaped multiple electrodes.

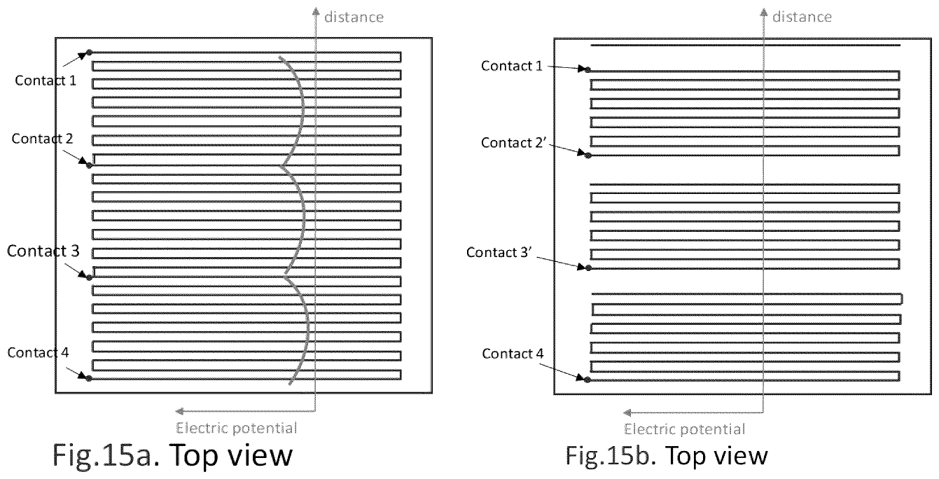

In still another different embodiment, the ITO same pattern (presented in FIG. 14a) may be used to generate also other types of dynamic profiles of electric potential, which may be used to build such components, as prisms or cylindrical lenses. Thus, if the ITO pattern parameters (as well as the parameters of the liquid crystal cell that will use such a pattern along with another electrode) are calculated in a way to drop the electric potential gradually from one contact to the mid way of the next contact, then the same potential may be applied to all electrodes and then we can generate cylindrical lens arrays (FIG. 15a). The bold green line represents schematically the corresponding profile of the electric potential.

In contrast, if we use “double” contacts (just by disrupting the line and by adding neighboring contacts such as in the in-plane-switch geometry, FIG. 15b) then we can apply phase shifted signals (to generate alternative current), then we can “force” specific profiles (including linear) of electric potential that may be used, for example, to generate prism arrays (FIG. 15b) and light steering. The advantage of this approach with respect to known in the art steering devices is the fact that there will be no leaking current between neighboring electrodes (thanks to the disruption), while the profile of the electric potential will still be controlled by the choice of the width and the separation of intermediate electrode lines.

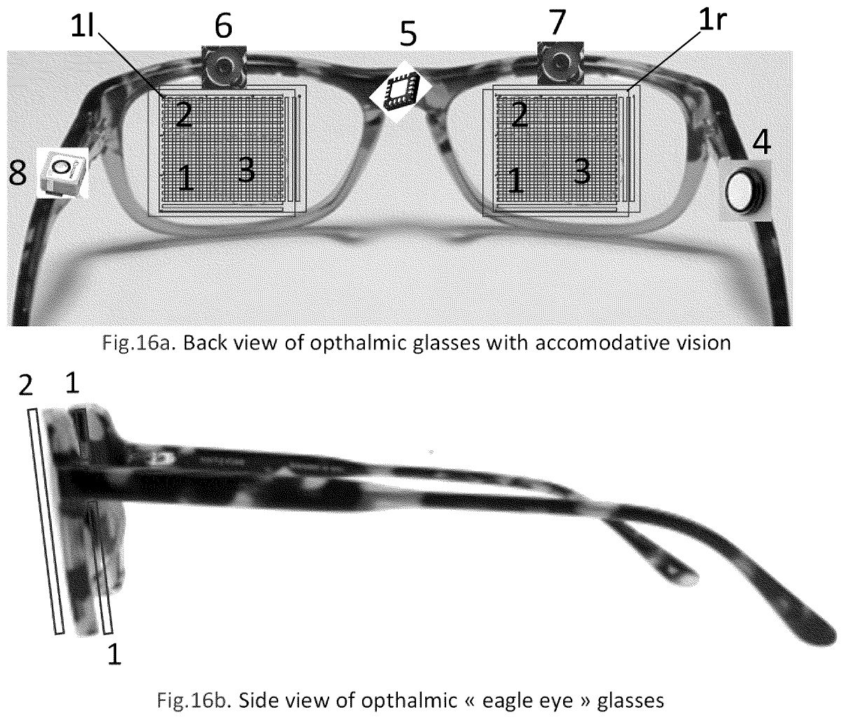

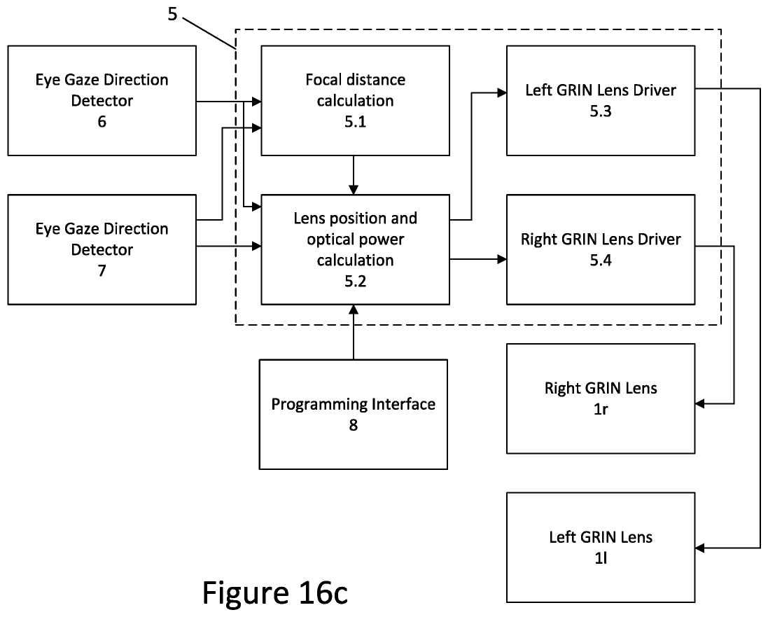

In another embodiment, the proposed lens (from FIG. 14c, but preferably polarization insensitive by using a combination of two liquid crystal cells either with perpendicular orientations of the ground state optical axis of the LC or by using the same orientation, but a polarization rotation, see hereafter) is used to build ophthalmic glasses (see FIG. 16a) to be used in day to day life, or in augmented reality or in other specific applications. The lens may be fabricated using thin glass or plastic substrates and it can be laminated over the surface (inner or outer) of the fixed focus ophthalmic lenses (glass or plastic). This will allow the dynamic distance accommodation as well as real time aberration correction (e.g., during an ophthalmic check-up). 1l is the left tunable lens and 1r is the right tunable lens (one for each side). 1 shows a possible position of a local tunable lens when the person is looking down-left. 2 shows the position and the diameter (dashed circle) of the lens generated for a specific distance of the object when the customer is looking on the top-left direction. 3 shows the position and the diameter (dashed circle) of the lens generated for another distance of another object when the customer is looking on the bottom-right direction. The lens can be powered for example, by solar elements (integrated on to the frame of glasses) or by a re-chargeable battery 4 (via a physical connection or inductively). 5 is the miniature driver used to control the lens as well as to optimize its performance at various conditions, including the temperature variations, etc. 6 and 7 are miniature cameras which can be used to track the orientation of human eyes and to estimate the distance of the “object” as well as its orientation. This will provide information about the position and the diameter of the dynamic lens to be generated. Such a device can enable enhanced foveal vision. A wireless interface 8 can be used to communicate with the driver 5 for configuration and/or reprogramming purposes. Ophthalmic consultation results can be used to reprogram and optimize the operation of the device along the aging of the customer or simply for customizing the device for different persons.

FIG. 16c is a block diagram corresponding to FIG. 16a schematically showing a possible interconnection of elements of the vision improvement apparatus.

In another embodiment, the proposed lens (from FIG. 14c) is used to build ophthalmic glasses with zoom capability (see FIG. 16b) providing an enhanced vision (“eagle eye”). In this case, each eye glass may have two such lenses (one on each, inner and outer surfaces), so a total of 4 tunable lenses. We shall thus have two tunable lenses separated by a fixed focus lens. Their dynamic adjustment, including in opposite directions (that is, the lens 1 is focusing while the lens 2 is defocusing) may provide optical zoom and/or image stabilization functions. In both cases, the use of a touch-sensor 3 (FIG. 16b) may be used for the control.

In another embodiment, the proposed lens (from FIG. 14c) can be incorporated with large angle (panoramic or fish-eye) cameras to provide a distortion correction or selective improved resolution and visibility zone capability by activating specific areas of the lens with specific diameters.

In another embodiment, the proposed electrically variable components, such as the element represented in FIG. 12c, can be used also in other then «focusing» modes. For example, they can be used to generate a linear gradient of the refractive index and thus steer light. Such steering elements may be used for lighting as well as in integrated photonic/fiber circuits to adjust the efficiency of coupling between different components. For example, a flat bundle of fibers can be roughly positioned close to the entrance or exit channels of a photonic integrated circuit and an optimization software can be used to focus and steer light from each fiber to optimize the connection between the integrated circuit channels and the fiber bundle. This can be even used for relatively low quality (mechanical precision) connectors.

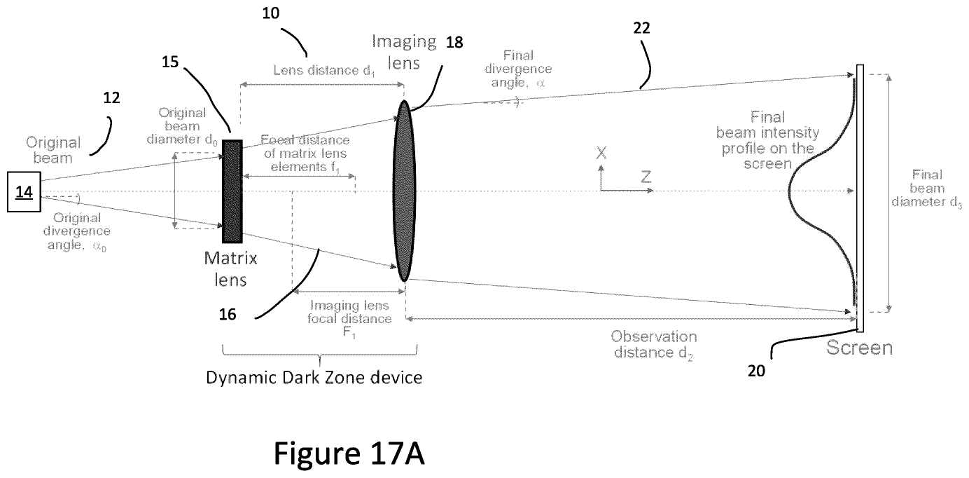

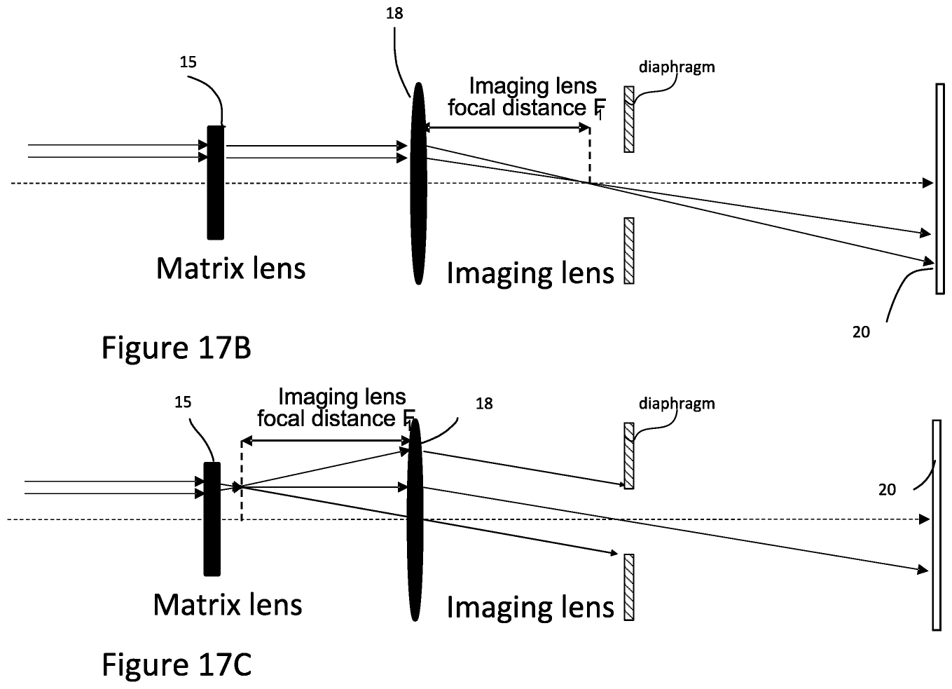

In another embodiment, the combination of an element capable of creating localized refractive index gradients (a matrix modulator device as described above) with an “imaging” optical lens (optionally with a stop or diaphragm) can enable the control of angular distribution of light. Thus, in the embodiment of FIG. 17A, an optical arrangement 10 receives an original beam 12 from a light source 14 that passes through a matrix beam modulator 15 followed by an imaging lens 18 to produce a beam 22 projected onto a screen 20. The matrix modulator 15 can be a suitable liquid crystal device. Device 15 can be electrically controlled to alter portions of the original beam 12. In the illustration of FIG. 17A, the beam 16 leaving device 15 is not modulated and the resulting beam 22 has a final beam intensity on the screen 20 that shows a Gaussian distribution (as an example). The selected portion or portions of the beam 12 that can be dynamically controlled can be specific selected portions of the beam 12 or it can be any desired portion of the beam in accordance with the electrode arrangement in device 15.

For example, device 15 may have a substrate with an array of controlled electrodes (e.g., along the z axis) covering its entire aperture as it is well-known in traditional “in-plane-switch” displays with LC material placed between such substrates, the LC material being aligned homeotropically or planar, for example. Device 15 may alternatively consist of polymer dispersed liquid crystals (PDLCs) device, or it may comprise one or more layers of LC and have hole-patterned electrodes. For example, whole patterned electrodes can be powered to create an array of micro lenses that will actively cause light passing through the liquid crystal to be diverted and thus diffused. Alternatively, strip electrodes may be provided for the purposes of creating micro cylindrical lenses that can likewise be selectively activated for diverting light as desired. Such micro-lenses may have an ability to focus or defocuslight or they may simply redirect or scatter light without focusing.

As illustrated in FIG. 17B, the above-mentioned matrix modulator 15 can comprise a matrix lens. In this Figure, the matrix lens 15 is not powered, and the portion (or the “zone of interest”) of the beam (shown by a couple of solid horizontal arrows on the top left part) passing through the matrix lens 15 is then focused by the imaging lens 18 to provide a spot on screen 20. In the case of FIG. 17C, the matrix lens is activated for the portion of the beam (the “zone of interest”) and is focused to the focal spot of the matrix lens causing it to diverge when reaching lens 18 with the result that the light from the portion of the matrix lands arrives at screen 20 in a broadened fashion. Thus, we obtain an intensity modulation by the angular redistribution of energy and without the use of polarizers that are traditionally used in display type solutions.

It will be appreciated that the use of an imaging lens 18 in combination with the matrix modulator 15 is optional depending on the optical arrangement. Likewise, the matching of the focal distances between a matrix lens 15 and the focal distance of an imaging lens 18, while able to improve the contrast or the loss of light in the “dark zone”, is a design choice. Similarly, various optical elements may be added to the design, for example, an optical stop or diaphragm (FIG. 17B) to improve the performance of the device (e.g., its contrast). When a matrix modulation device 15 is employed to alter the original beam, the natural result is that the light intensity passing through that portion of the matrix modulation device 15 will be angularly redistributed.

In another embodiment, the described above approach may be used to re-shape the light distribution in an angularly selective way, and, even, to obtain sharp edges (abruptly decreasing the light intensity in the periphery of the beam), which can create an impression of higher intensity and better beam quality.

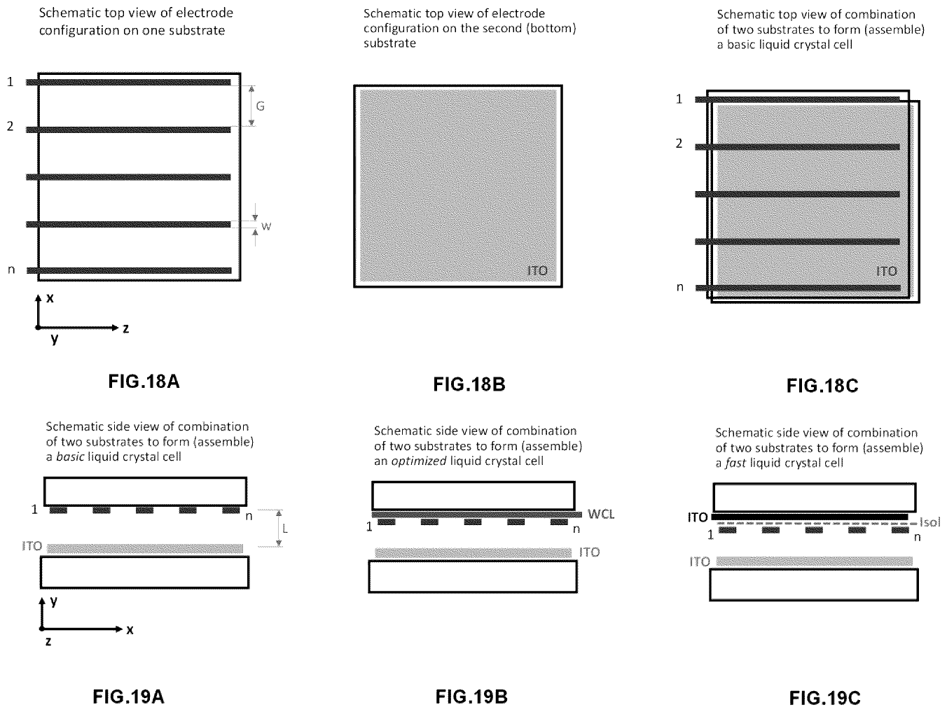

While modulator 15 can take many different forms, an example of an LC device using strip electrodes is illustrated in FIGS. 18A to 19C. FIG. 18A is a schematic top view of an electrode configuration on a first substrate. This first substrate can have individually controlled strip electrodes 1 through n of width w and a gap between them of G of the thickness L of the LC is chosen well to spread the electric potential in the desired optimal way. The strip electrodes can be deposited on the substrate, for example a glass substrate, and the electrodes can be transparent, for example made of indium tin oxide or ITO. An opposed second substrate can be provided with a uniform electrode, also for example made of ITO, as shown in FIG. 18B. In FIG. 18C the plan view superposition of the two substrates is shown.

FIG. 19A shows a side view of FIG. 18C looking in the Z direction. LC material can be filled between the two substrates. The LC material can have a ground state orientation, such as homeotropic (i.e. aligned to be perpendicular to the substrates) or planar (i.e. aligned with a pre-tilt angle from being parallel to the substrates), or a specific angle (between 0 and 90 degrees) with respect to cell substrates, and an alignment layer on the substrates in contact with the LC material can be provided for imparting to the LC material its ground state alignment.

FIG. 19B shows an embodiment in which a layer of weakly conductive material (WCL) is added near the strip electrodes. This WCL couples with the electric potential on the strip electrodes and acts to provide an electric potential profile across the gap G. This can allow the strip electrodes to create an electric field profile between the strip electrodes that can create a better optical quality to the lens, for example in the case illustrated the cylindrical lenses created by the strip electrodes.

FIG. 19C shows another embodiment in which a uniform electrode is added near the strip electrodes. An insulation layer separates the strip electrodes from the uniform electrode. This uniform electrode can be used to apply an electric field that “resets” the LC material, namely it can cause the LC to have a spatially uniform orientation that makes the LC layer uniform and transparent. Since the normal relaxation of the LC material into the ground state can take some time, the uniform electrode can allow for a faster operation.

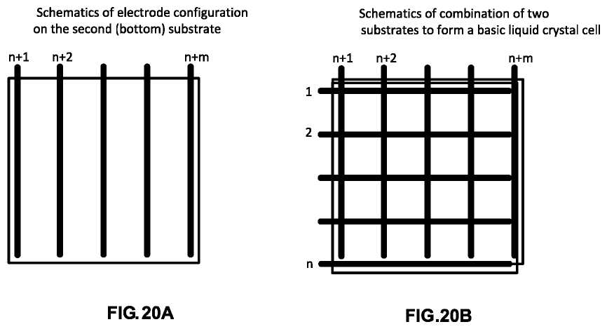

FIG. 20A is the same substrate and electrode disposition as FIG. 18A, however, in FIG. 20B, it can be seen that the opposed substrate does not have a uniform electrode, but instead orthogonally arranged strip electrodes. These strip electrodes may have the same width and G arrangement as the electrodes shown in FIG. 20A. The superposition of the two substrates is shown in FIG. 20C.

Without adding to the arrangement in FIG. 20C any uniform electrode, various light modulations are possible. If the LC material has a homeotropic ground state, the electrodes on either substrate can be powered to provide a cylindrical lens using in-plane control. The orientation of the lens is determined by the choice of the electrodes to be powered. This mode of operation does not use the WCL, and the optical quality of the lens can be poor. The contrast of the dark zone can be somewhat reduced depending on the optical arrangement.

With planar ground state orientation or homeotropic orientation of the LC material, the arrangement of FIG. 20C can be enhanced by adding uniform electrodes, so that the opposed uniform electrode can be used to provide a suitable electric field for creating cylindrical lenses. In some embodiments, the opposed uniform electrodes can be segmented into wide strips spanning the gap G of the opposed electrodes. When the segmented wide strips are all powered together, they will also act as a uniform electrode for improving speed of operation.

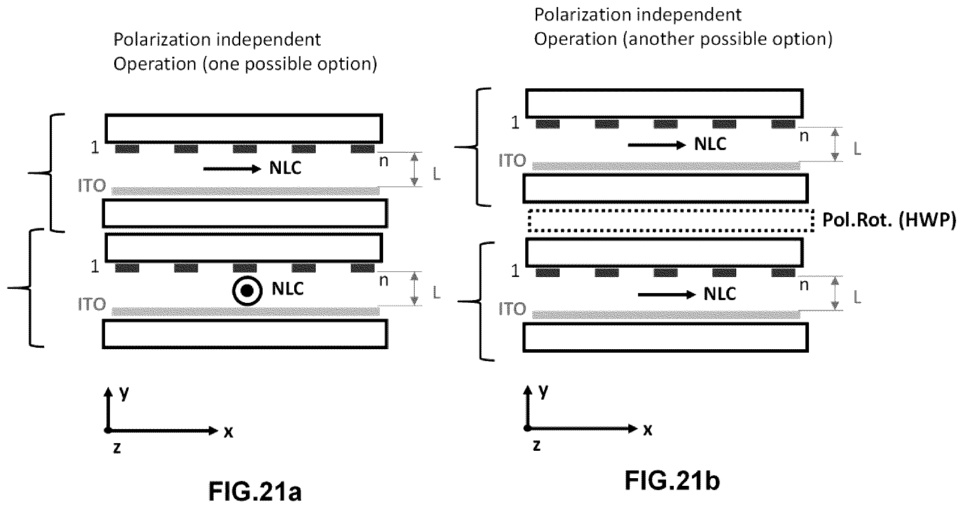

The embodiment of FIGS. 21A to 21C illustrates an electrode arrangement that can replace the function of the WCL. Between the strip electrodes 1 to n of width w there is provided a narrower serpentine-like arrangement of electrode that due to its narrower width is of higher resistance. An electric potential applied between two strip electrodes, say between electrodes 1 and 2 or between 1 and 3 (making a cylindrical lens twice as wide), the potential decays along the length of the serpentine connector. As with the WCL, when the electrodes are powered using AC power, the electrodes 1 and 2 or 1 and 3 can be connected to the same potential and the potential at the surface of the substrate across the gap G is spatially varied, for example having a gaussian distribution, that improves the spatial profile of the electric field acting on the LC material.

It is well known that often the natural or artificial light is unpolarized (that is, may be presented as a sum of two orthogonal polarized light components). Due to the nature of some LC materials (e.g., nematics), light must be polarized since the LC modulator may act on only one polarization. However, the use of a polarizer (as it is done in traditional display industry) is highly undesired due to the loss of energy, increase of cost and reliability degradation. FIG. 21A illustrates an embodiment in which two LC modulators are combined to act on both linear (orthogonal) polarizations of light. The top modulator has its ground state NLC molecules oriented, for example, perpendicular to its stripe electrodes. In the same time, the bottom cell has a similar electrode configuration, but the NLC molecules are perpendicular with respect to the top modulator. Thus, they are parallel to the stripes of the bottom modulator. With this arrangement, the combined modulator can act on natural light having a mixture of two orthogonal polarizations. However, the operation of the device risk to be asymmetric (not the same for these polarization components). FIG. 21B illustrates an embodiment in which two identical LC modulators are combined to act on both linear polarizations of light, however a polarization rotation element or half wave plate is placed between the two modulators while the orientation of the electrodes and of NLC molecules are the same for the top and the bottom modulators. It is worth mentioning that multiple such devices can be assembled together allowing the light modulation in various plans.

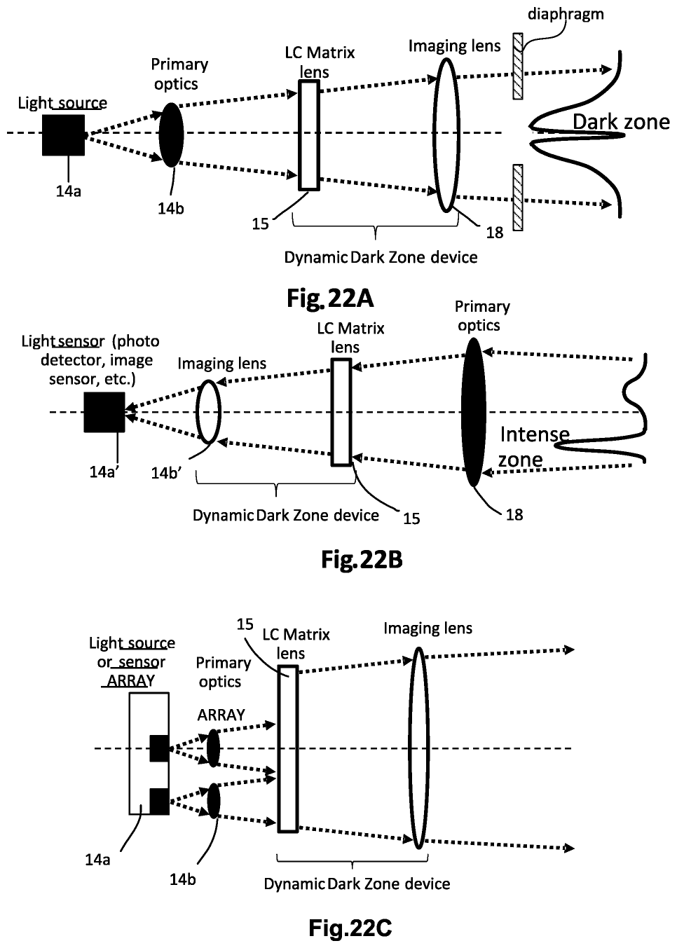

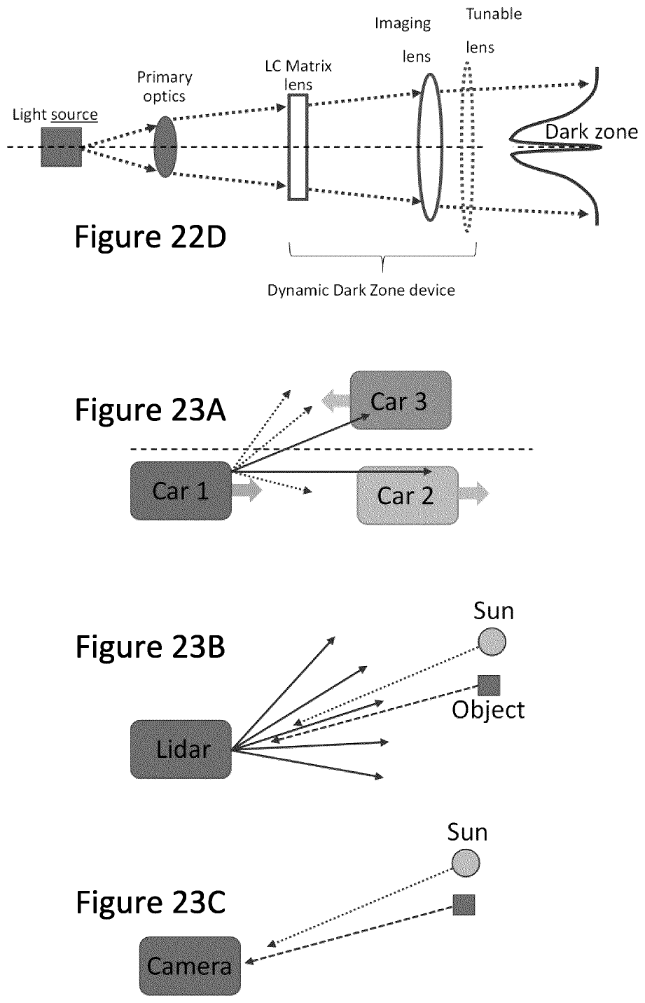

FIG. 22A shows an optical arrangement having a light source 14A coupled with primary optics 14B that produce a beam passing through LC matrix modulator 15 (from left to right). The beam continues through a lens 18 to be projected. As illustrated, the device 15 can be controlled to create a “dark zone” at a desired location within the spot beam by activating the desired portion or region within the LC device 15 to divert light. As previously mentioned, the light source 14 may not require separate optics for producing the source beam, and the imaging lens 18 may be of various characteristics depending upon the application.

It will be appreciated that the use of the matrix modulator allows for a creation of a dark zone without needing to resort to a light source comprising micro LED elements that are multiplexed to provide a beam with the ability to control the spatial distribution of the light beam.

FIG. 22B illustrates another embodiment in which the optical arrangement is used to receive a beam rather than to project one. In this embodiment, the scene being imaged (light propagates from right to left) has a bright spot that is not of interest for the image to be acquired. Collecting the image with the bright spot included can adversely affect image collection, for example due to saturation, damage to the sensitive image sensor or detrimental automatic gain control (AGC) in the image acquisition that would result in the region of interest away from the bright spot being too dark and thus difficult to analyse. It will be appreciated that the embodiments described herein that relate to modulation of a projected beam can equally be applied to beam sensing. This technique can be used as in ordinary photography as well as in LIDARS and other sensing applications.

FIG. 22C illustrates an embodiment in which the proposed device can be used with an array of light sources or sensors 14a. This array of sources or sensors can be optionally associated with an array of primary optics 14b (collimating the outcoming beam from individual sources or focusing the incoming light in into individual sensors). With the use of the spatial control offered by the matrix device 15, the operation of the array 14a can be significantly enhanced. For example, in addition to the creation of dark zones (as described above), we can also steer individual units into the same direction or divert them into various directions, or we can stretch light in one (e.g., vertical) or other (horizontal) directions by generating cylindrical lenses inside the matrix device, etc. We can also use the device as a block without having to perform spatial modulation control within 14a, etc.

FIG. 22D illustrates including in the combination with a tunable lens. By changing the optical power of the tunable lens, additional control over the dark zone properties is made possible. In the case of a narrow beam, such a tunable lens may be used to focus light. Most often, it can/should be positioned just after the primary optics. In the case if we wish to use it behind the matric lens, very often the beam diameter will be large, and the tunable lens may be an array of micro lenses. In this case, it can provide additional broadening angle. In all these cases, the projected beam's shape and form may be thus controlled additionally.

Examples of applications for the embodiments of FIGS. 3A through 3D are shown in FIGS. 23A to 23C.

In FIG. 23A, there is illustrated an application in which the headlight of a vehicle, car 1, can be modulated using device 15. When another vehicle, car 2, is detected to be in front of the car 1 (moving approximately in the same direction), an upper horizontal strip-like portion of the headlight beam (of the car 1) can be darkened to reduce the brightness of the headlight shining into the rear window and mirrors of car 2. Similarly, when another vehicle, car 3, is detected to be moving in the opposite direction to car 1, an other vertical side strip-like portion of the headlight beam can be darkened to reduce the brightness of the headlight shining into the windshield of the opposing vehicle. The angular positions and other characteristics (such as depth and width of modulation) of these dark windows may be dynamically adjusted as the relative position of cars changes.

In FIG. 23B, a LIDAR system is illustrated whose optical arrangement includes device 15. By dynamically activating the portion of the device 15 corresponding to the scene in which a bright object is found, such as the sun, the dark zone created can prevent the influence of the bright spot on the LIDAR system. Similarly, in the case of FIG. 23C, device 15 is used to darken the sun in the camera image. In the case of a camera, it may be desirable to arrange device 15 within the camera optics so that the dynamic redirection of light within the selected portion of the beam causes the redirected light to be outside the stop or diaphragm and thus not introduce any background noise in the rest of the image.

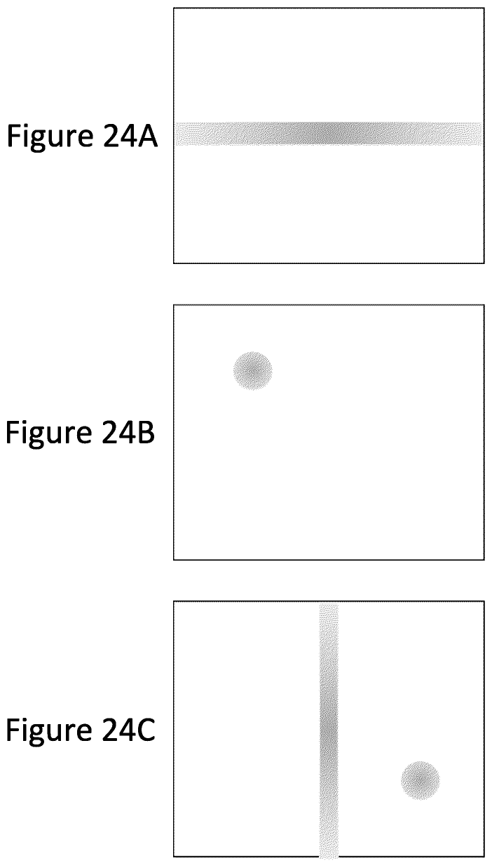

FIGS. 24A to 24C schematically illustrate the formation of a horizontal dark line alone, a dark spot alone or the combination (simultaneous formation) of a dark spot with a dark (vertical) line. In FIG. 24A, can be obtained by using a subset of the electrodes in one direction (horizontal), powered in the specific area of the device 15 (to form a single cylindrical lens). In the case of FIG. 24B, subsets of the strip electrodes in orthogonal directions are powered (with specific phase shifts for electrodes at various substrates) to produce a small square-like region in which a single circular lens appears. As illustrated in FIG. 24C, more than one lens can be created within the aperture of device 15, either by having separated electrodes for different portions of the aperture, or by time-multiplexing the powering of electrode arrays for the plural lenses.

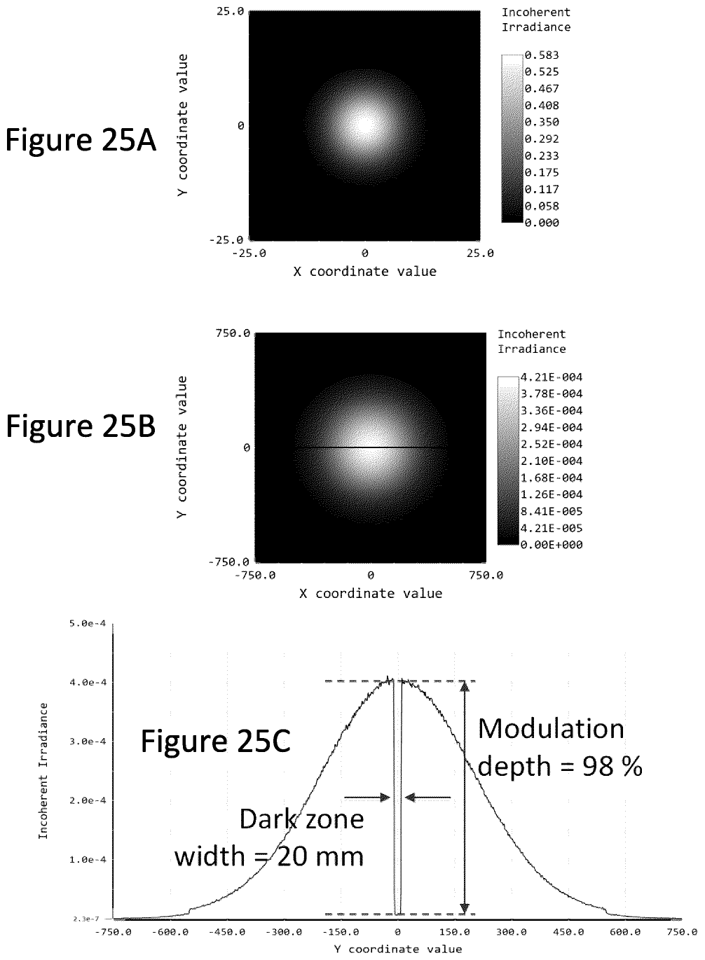

FIGS. 25A to 25C illustrate simulation results. Non sequential Zemax simulations were used to demonstrate the operation of the proposed device 15. An example of experimental parameters is presented in the Table 1:

| Parameter | Value | |
|---|---|---|
| Source FWHM | 6 | deg. |
| Lenslet diameter | 0.5 | mm |
| Active lenslet focal length | 0.5 | mm |
| Source to lenslet array distance | 100 | mm |
| Lenslet array to imaging lens distance | 80 | mm |
| Imaging lens focal length | 100 | mm |
| Imaging lens to screen distance | 5.0 | m |

The light intensity distributions as simulated are shown at the position of the matrix lens, FIG. 25A, at the screen, FIG. 25B, and the corresponding intensity distribution, FIG. 25C for the case of activation of a cylindrical miniature lens (like the one shown in FIG. 24A) in the matrix lens array 15. As can be seen, a significant intensity modulation depth of 98% can be achieved in this embodiment at the center of the beam.

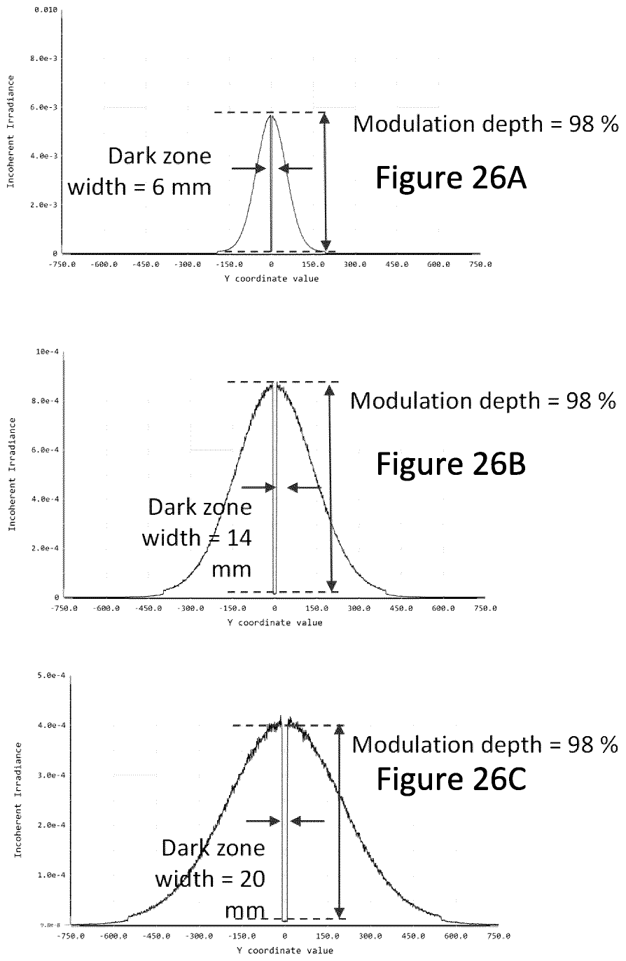

FIGS. 26A, 26B and 26C illustrate the simulated beam intensity in the Y axis at screen distances of 1.5 m, 3.5 m and 5.0 m respectively for the same simulation parameters (presented in the Table 1). These simulations show that the width of the generated dark zone scales with distance, while the modulation depth is preserved. This can be taken into account when designing the specific application.

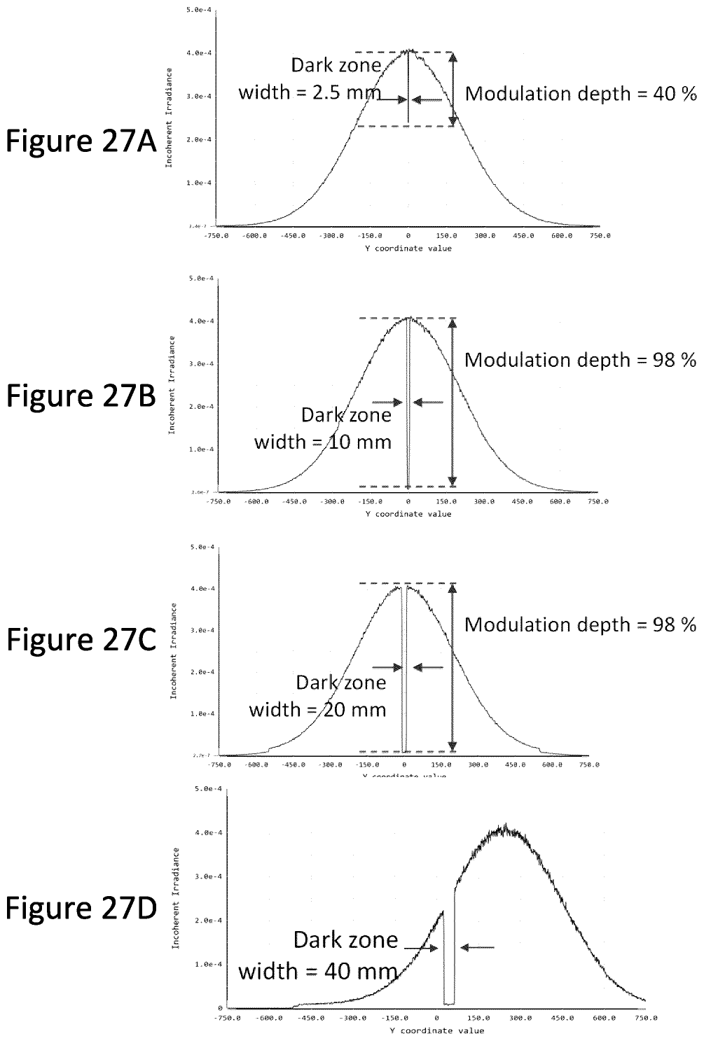

FIGS. 27A to 27D show how the choice of the diameter (0.05 mm, 0.25 mm and 0.5 mm for FIGS. 27A to 27C respectively) of the activated cylindrical microlens of the matrix lens 15 for the same simulation parameters (presented in the Table 1) affects both the width of the generated dark zone scales as well as the modulation depth. This choice can be made by designing the corresponding electrodes (of the matrix lens 15) or by activating multiple micro lenses at the same time. Thus, FIG. 27D shows such an example (same parameters as in Table 1), when two neighboring microlens arrays are activated simultaneously (providing even greater width of the dark zone).

FIGS. 27A to 27D show how the choice of the diameter (0.05 mm, 0.25 mm and 0.5 mm for FIGS. 27A to 27C respectively) of the activated cylindrical microlens of the matrix lens 15 for the same simulation parameters (presented in the Table 1) affects both the width of the generated dark zone scales as well as the modulation depth. This choice can be made by designing the corresponding electrodes (of the matrix lens 15) or by activating multiple micro lenses at the same time. Thus, FIG. 27D shows such an example (same parameters as in Table 1), when two neighboring microlens arrays are activated simultaneously (providing even greater width of the dark zone).

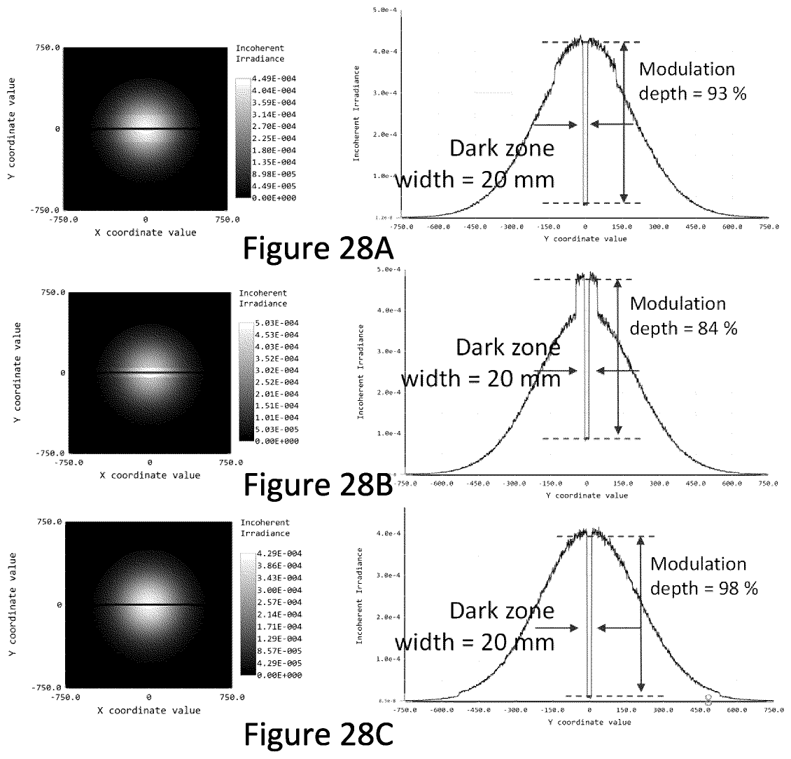

FIGS. 28A to 28C illustrate on the left side the beam intensity image and on the right side the corresponding beam intensity along the Y axis for the case of the focal distance of the microlens chosen to be −2.0 mm, −5.0 mm and −0.5 mm, respectively. The most interesting case, of course, is the dynamic change of the focal distance of the microlens (since we can continuously change it or switch it ON and OFF). Some examples (using the same simulation parameters, presented in the Table 1) of obtained intensity distributions are shown on the right side of FIGS. 28A to 28C, when the focal distance of the microlens is changed. In this way, for example, not only can we create an intensity depression (FIG. 28C), but also, we can generate different types of light redistribution (FIGS. 28A and 28B).

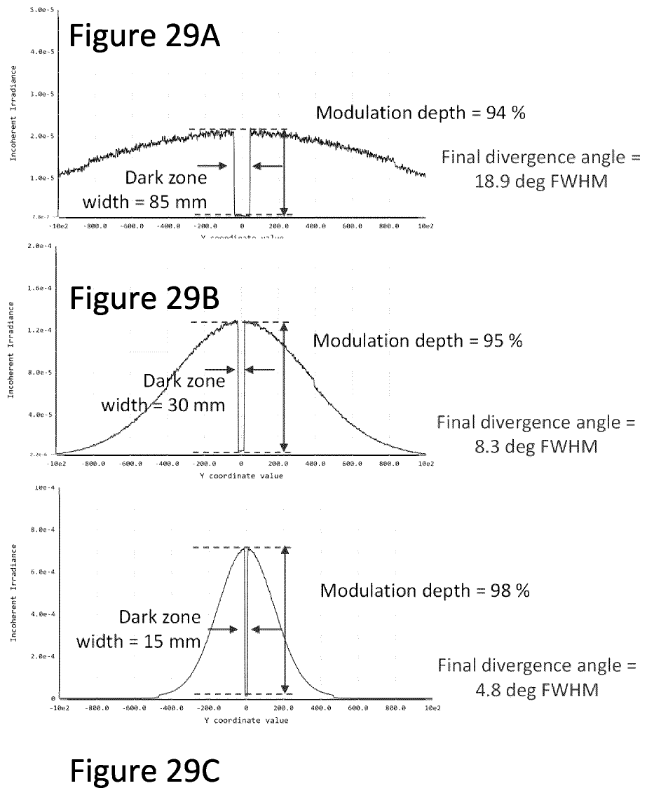

In some embodiments, the optical arrangement 10 can have extra ordinarily large choice of functionalities. For example, by the choice of the focal distance (e.g., −50 mm, 50 mm and 75 mm) of the imaging lens 18 (or we can also chose to have an imaging lens with tunable focal distance) we can further modify the light distribution pattern as demonstrated in FIGS. 29A to 29C for the imaging lens focal length of −50 mm, 50 mm and 75 mm, respectively, for the physical parameter values presented in Table 2:

| Parameter | Value | |
|---|---|---|
| Source FWHM | 6 | deg. |
| Lenslet diameter | 0.5 | mm |
| Active lenslet focal length | 2.0 | mm |
| Source to lenslet array distance | 100 | mm |
| Lenslet array to imaging lens distance | 20 | mm |
| Imaging lens focal length | variable | |
| Imaging lens to screen distance | 5.0 | m |

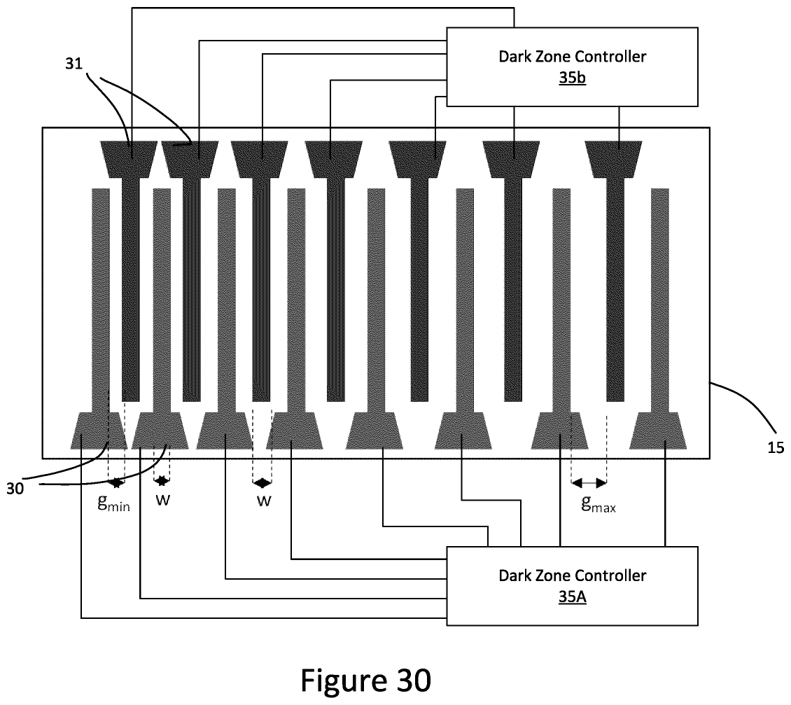

To confirm experimentally the above-mentioned predictions, we have built a simple matrix lens 15 of one dimension (1D), that can generate cylindrical lenses of different diameters, but all in one direction (say, vertical, see the schematic diagram of FIG. 30. One of the cell substrates is covered by a uniform indium tin oxide (ITO) electrode, while the second one has individually controlled “finger” type (or interdigitated) electrode pairs (30 and 31).

In this embodiment, a controller 35a is connected to each electrode 30, while a separate controller 35b is connected to each electrode 31. Such a controller 35 can be a single controller if desired. It comprises switches for selectively powering the individual electrodes. The input to such a controller can be data signals, as for example a serial input for a scan chain control. Since the electrodes can comprise any spatially controllable electrode array having any desired geometry, the controller 35 can likewise be adapted for the type of electrode array.

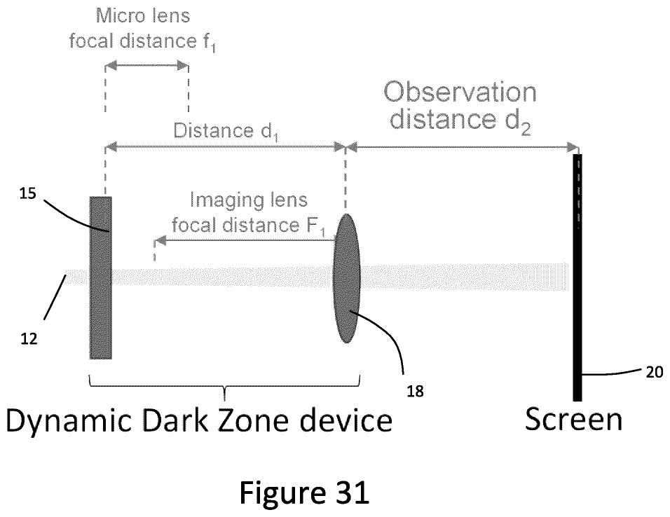

The width of the ITO electrodes is w=10 μm. The distance of the first pair (on the left) of the electrodes gₘᵢₙ=50 μm and increases by 10 μm increment. Thus, the distance of the last pair (on the right) of electrodes is gₘₐₓ=170 μm. The working zone is shown by the rectangle. Different driving techniques may be applied, for example, we can activate one of the finger electrodes while all others including the uniform ITO) are grounded. The experimental parameters were: homeotropic aligned ceLC (NLC6028) ll gap=40 μm (optical birefringence Δn=0.2); f₁ of lens 18 (see FIG. 31) is electrically tunable, F₁=10.5 cm, d₁≈10 cm and d₂=variable during the experiment (see below). The original beam's 12 divergence angle is 1.5°.

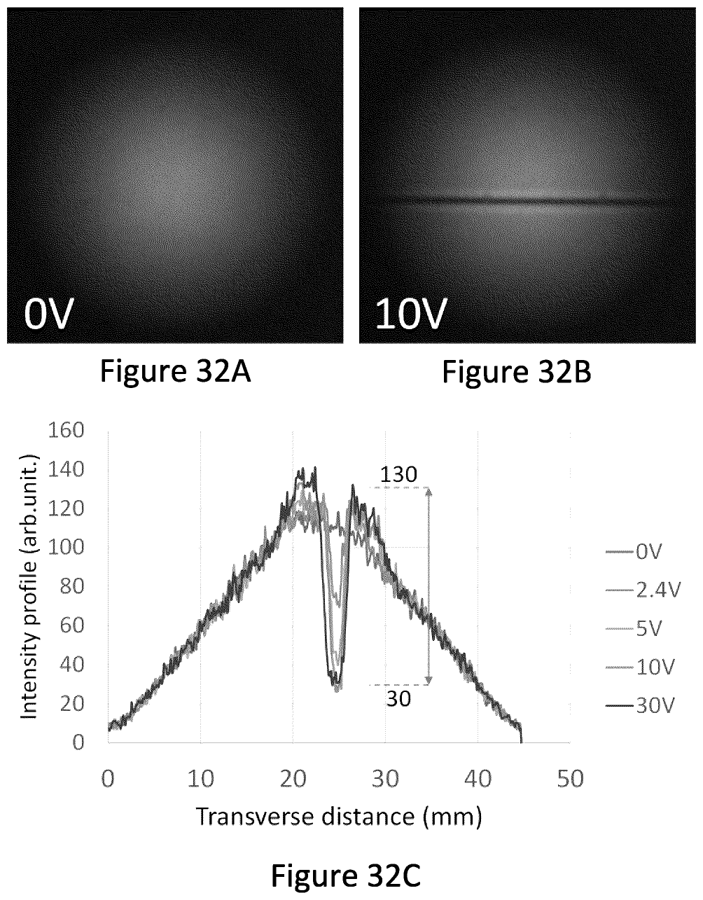

FIG. 32A shows the image of the transmitted beam in the ground state (0V), while FIG. 32B shows the image of the beam at 10V. FIG. 32C shows the intensity distribution across the beam on the screen vs applied voltage. (the screen is located at d₂=130 cm far from the imaging lens). As we can see, the modulation depth is approximately 77% and it can be dynamically tuned.

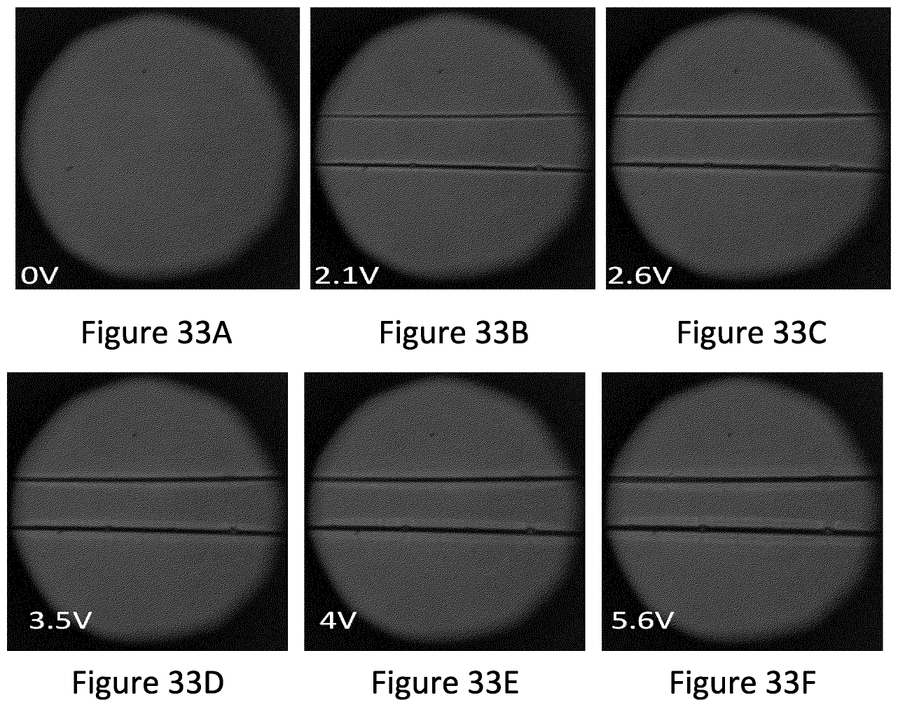

FIGS. 33A to 33F show images using two simultaneously generated cylindrical micro lenses that generate two dark zones in corresponding angular zones, for example, to avoid exposing the drivers of co-propagating (exposure via the mirror) and counter propagating (direct exposure) cars (see FIG. 23A). One of these dark windows may be more or less in the same angle (for the co-propagating car), while the second one (for the counter-propagating car) may be shifted dynamically.

What is claimed is:

1. A liquid crystal gradient index (LC-GRIN) optical device comprising:
opposed substrates containing liquid crystal with a first stepped electrode arrangement on a first one of the substrates and a second electrode on a second one of the substrates; and
a transparent relatively high dielectric constant layer (HDCL) placed near the stepped electrode arrangement.

2. The optical device as defined in claim 1, wherein said stepped electrode arrangements comprise spiral electrodes with one or multiple external control contacts positioned on the same substrate surface or on various surfaces of the same substrate.

3. The optical device as defined in claim 1, wherein said stepped electrode arrangements comprise continuous serpentine electrodes.

4. The optical device as defined in claim 1, wherein said stepped electrode arrangements comprise capacitively-coupled linear or circular electrode segments.

5. The optical device as defined in claim 1, wherein said stepped electrode arrangements comprise individually driven electrode rings or electrode segments.

6. The optical device as defined in any one of claims 1 to 5, wherein said device is used to build a prism, cylindrical or circular lens.

7. The optical device as defined in any one of claims 1 to 6, wherein said transparent HDCL placed near the stepped electrode arrangement has a dielectric constant of about 20 or greater.

8. The optical device as defined in claim 7, wherein said transparent HDCL placed near the stepped electrode arrangement comprises a layer of Ti₃O₅.

9. The optical device as defined in claim 7, wherein said transparent HDCL placed near the stepped electrode arrangement comprises a layer of HfO₂ that can also play the role of the index matching layer.

10. A liquid crystal gradient index (LC-GRIN) lens device comprising:
two opposed substrates containing liquid crystal with a first linear stepped electrode arrangement on a first one of the substrates and a second linear stepped electrode on a second one of the substrates;
wherein said linear stepped electrode arrangements are orthogonal to each other and in use can be powered to form a prism or a cylindrical lens or a circular lens.

11. The lens device as defined in claim 10, wherein said stepped electrode arrangements comprise continuous serpentine electrodes.

12. The lens device as defined in claim 10, wherein said stepped electrode arrangements comprise capacitively-coupled electrode segments.

13. The lens device as defined in claim 10, wherein said stepped electrode arrangements comprise individually driven electrode segments.

14. The lens device as defined in any one of claims 10 to 13, further comprising a transparent HDCL placed near the linear stepped electrode arrangements.

15. A liquid crystal gradient index (LC-GRIN) lens device comprising:
opposed substrates containing liquid crystal with first stepped linear electrode arrangement on a first one of the substrates and a second similar stepped electrode arrangement on a second one of the substrates;
wherein the electric field provided by each linear electrode arrangement on each substrate allows for the formation of a cylindrical variation in the electric field in the desired position of the entire optical window, the combination of which can be used to form a circular lens of the desired diameter.

16. The lens device as defined in claim 15, wherein said addressable linear electrode arrangements comprise continuous serpentine electrodes.

17. The lens device as defined in claim 15, wherein said addressable linear electrode arrangements comprise capacitively-coupled electrode segments.

18. The lens device as defined in claim 15, wherein said addressable linear electrode arrangements comprise multiple individually driven electrode segments.

19. The lens device as defined in claim 15, wherein said addressable linear electrode arrangements comprise driven electrode segments in combination with a highly resistive layer connected to and filling a gap between said segments.

20. A vision-improvement apparatus comprising:
an eye-tracking device;
a rechargeable power source;
a polarization insensitive lens device composed of lenses as defined in any one of claims 15 to 19; and
a driver receiving an eye-position signal from the eye-tracking device and providing a drive signal to said addressable linear electrode arrangements to cause a lens of a suitable optical power to appear on the desired position of said lens device for focusing an image onto a foveal region of the eye.

21. The lens device as defined in claim 20, wherein said polarisation insensitive lens device is integrated into an “ophthalmic” glass system from one side of glasses to provide accommodative vision and aberration correction by; using eye tracking system and powering and driving electronics.

22. The lens device as defined in claim 20 and claim 21, wherein said polarisation insensitive lens device is integrated from both sides of glasses to provide accommodative vision, aberration correction, magnification and enhanced vision.

23. The lens device as defined in claims 20-22, wherein said polarisation insensitive lens device is driven with time sequential addressing phase shifted electrical signals to create the local lens effect mainly in the desired region of the device.

24. A large angle recording or surveillance improvement apparatus comprising:
a motion detection capability to identify a region of interest on the scene;
a polarization insensitive lens device composed of lenses as defined in any one of claims 15 to 19; and
a driver receiving the motion detection signal and providing a drive signal to said addressable linear electrode arrangements to cause a lens of a suitable optical power to appear on the desired position of said lens device for focusing an image, locally improving resolution or correcting aberrations and distortion.

25. A liquid crystal optical device for controllably obscuring a portion of a field of view, the device comprising:
an electrode array having distinct spatially arranged electrodes for controlling liquid crystal orientation differently at different locations over an aperture of said device, wherein when said electrode array is operative to cause said device to change from a transparent state to a light diverting state at said different locations over an aperture of said device; and
a controller connected to said electrode array configured to switch power to said electrode array in accordance with an input signal selecting one or more given ones of said different locations over the aperture of said device.

26. The device as defined in claim 25, wherein said device comprises at least one layer of liquid crystal material and said electrode array is arranged to act on said at least one layer to focus light.

27. The device as defined in claim 25 or 26, wherein said controller is configured to switch power to more than one of said different locations over the aperture of said device.

28. An optical arrangement for controllably obscuring a portion of a field of view, the arrangement comprising:
a liquid crystal optical device as defined in any one of claims 25 to 27; and
an imaging lens.

29. A controllable light projector for producing a light beam with a controllable obscured portion of the light beam, the projector comprising:
a light source;
the optical arrangement as defined in claim 28.

30. A light sensing apparatus for sensing light from a field of view with a controllable obscured portion of the field of view, the apparatus comprising:
the optical arrangement as defined in claim 28; and
a light sensor operatively coupled to said optical arrangement for receiving light from said field of view.

31. A method for sensing light from a field of view, the method comprising:
optically collecting a beam of light from said field of view;
capturing said beam on an image sensor at an image plane;
measuring a brightness of light at different locations within said image plane;
determining which portion within said image plane requires obscuring; and
using a liquid crystal optical device for controllably obscuring said portion.
